(19) United States
(12) Patent Application Publication
(10) Pub. No.: US 2014/0007777 A1
(43) Pub. Date: Jan. 9, 2014

(54) LIQUID OVERFLOW CAPTURE DEVICE FOR SMALL APPLIANCES

(71) Applicants: Bobbi J. SWEET, BOISE, ID (US); Jeff GRAVES, BOISE, ID (US)

(72) Inventors: Bobbi J. SWEET, BOISE, ID (US); Jeff GRAVES, BOISE, ID (US)

(21) Appl. No.: 14/022,506

(22) Filed: Sep. 10, 2013

Related U.S. Application Data
(63) Continuation-in-part of application No. 13/022,602, filed on Feb. 7, 2011, now Pat. No. 8,528,466.
(60) Provisional application No. 61/302,083, filed on Feb. 5, 2010.

(51) Int. Cl. A47J 31/44

(52) U.S. Cl. CPC A47J 31/4428
USPC 99/290

(57) ABSTRACT

A liquid-overflow device includes a generally horizontal platform for catching overflow liquid from a small appliance, such as a coffee maker, and a container beneath the platform that receives the liquid flowing through aperture(s) in the platform. The platform may be topographically structured to direct liquid to the apertures, and/or may be larger than the footprint of the appliance in order to extend outward beyond the appliance footprint in all horizontal directions. The container contains more than the liquid capacity of the appliance. The device is preferably removable from beneath the appliance for carrying to an appropriate place to empty the contents, preferably by tipping the device to drain the liquid out through corner/outer perimeter apertures. The device may be separate from and not connected to the appliance, may be connected but removable from the appliance, or may be integrally connected to the appliance.

This application claims benefit of Non-Provisional application Ser. No. 13/022,602, filed Feb. 7, 2011, entitled LIQUID OVERFLOW PLATFORM AND CONTAINER FOR SMALL APPLIANCES, and issuing on Sep. 10, 2013 as U.S. Pat. No. 8,528,466, which claims priority of Provisional Application 61/302,083, filed Feb. 5, 2010 and entitled PLATFORM-OVERFLOW CONTAINER, the disclosures of both of which applications are incorporated herein by this reference.

### BACKGROUND OF THE INVENTION

Injury or damage of property often occurs when liquid overflows from a small appliance when the appliance malfunctions. For example, when hot liquid overflows a coffee maker, due to coffee maker malfunction and/or due to user error when setting up or using a table-top coffee maker, the liquid often misses the interior of the carafe and flows over the counter, down the cabinet doors, into the lower cabinets, and/or onto the floors. Coffee makers often malfunction at home and at the office and at all hours of the day, especially in view of many coffee makers being programmable to start operation when the user is not present. The valve mechanism of many coffee makers, which is intended to stop flow when the carafe is removed for pouring of “a first cup”, can often malfunction, especially if the carafe is not properly positioned. Therefore, the coffee grounds cone/tray often fills up with liquid and overflows. Further, many coffee makers and carafes break or crack, and water or coffee may leak out through the breaks/cracks to the table, countertop, cabinet and/or floor.

These common occurrences can cause a variety of injuries to the user or other people in the vicinity, such as burns, slipping on wet surfaces, and electrical shock. Coffee maker or other small appliance malfunctions can cause water damage or staining damage of valuable property and possessions, such as counter tops, grout, desks, cabinet doors, cabinet interiors, hardwood floors, carpeting, walls, irreplaceable items, and documents, etc. While coffee makers are the most common cause of such damage, water carafe or reservoir, or other hot or cold liquid-containing devices may also cause such damage, due to malfunction, breakage, or cracks in the device.

### SUMMARY OF THE INVENTION

The invented liquid overflow capture device comprises a generally horizontal platform with an attached or integral container beneath it. In certain embodiments, the device is placed underneath a small appliance and is entirely separable from the appliance for carrying of the device to, and emptying liquid from the device into, a disposal system such as a sink. In certain embodiments, the container portion of the device is separable from the rest of the device and/or the appliance, for carrying of the container to, and emptying liquid from the container into, a disposal system such as a sink.

In certain embodiments, the platform and container of the device are both adapted for complete or near complete capture of overflowing, spilling, or leaking liquid from the small appliance, and for effective and safe transport and emptying. In certain embodiments, the platform comprises one or more apertures that are structured to allow liquid to drain from the upper surface of the platform into the container, and the device comprises adaptations that encourage the liquid to drain to the aperture(s) rather than over an edge of the device. Said adaptations may comprise overflow barriers that prevent liquid from overflowing the outer perimeter of the device, and/or structure for directing liquid flow for example, directing means such as concavity, channels, recesses, stepped surfaces, or rims or ridges that direct liquid flow to the aperture(s) by virtue of gravity. Said barriers and/or directing means may be provided on the upper surface of the platform and/or on the sidewall(s) of the container, for example.

One example of a barrier is an upending rim at or near the outer edge of the device may prevent overflow of liquid over said outer edge of the device, thus serving as a dam that retains the liquid until it reaches a position or level whereby it will flow by gravity into one or more apertures. While preferred embodiments of liquid-damming rims extend continuously all the way around the device (typically around or as part of the sidewall), certain embodiments may comprises rims that extend substantially but not continuously around the entire device/sidewall. In certain embodiments, the aperture(s) are provided at/against the upending rim, so the liquid that is dammed-in by the rim tends to flow into the immediately-adjacent aperture(s), and so that the aperture(s) at the rim may serve as a pour spout for emptying the container of the liquid.

In certain embodiments, the aperture(s) constitute a small portion of the upper surface area of the platform, but the barriers or directing means are so provided, that the liquid naturally flows (by gravity) into the aperture(s) rather than flowing over the edge of the device. In certain embodiments, there is no need for a barrier at/near the outer perimeter of the upper platform and/or no need for aperture(s) to extend all the way (or substantially all the way) around the outer perimeter of the upper platform, as directing means will ensure that liquid flows to the aperture(s) by gravity.

In certain embodiments, the size and/or placement of the platform compared to the appliance, and/or the number and/or placement of apertures on the platform, may cause liquid to flow into the aperture(s) rather than to flow over the edge of the device. For example, the platform may be substantially larger than the footprint of the small appliance received on it, and the upper surface area of the platform may extend underneath and all around the appliance, and may extend horizontally out beyond the appliance footprint all around the appliance. In certain of these embodiments, especially those that do not have barriers or directing means, the aperture(s) may constitute a large portion (for example, up to about 95 percent) of the upper surface area of the platform, so that the liquid naturally flow into the aperture(s) by gravity rather than flowing over the edge of the device. Alternatively, in certain of these embodiments, the aperture(s) may constitute a smaller portion (for example, up to about 50 percent) of the upper surface area of the platform, but the apertures may be positioned away from the center of the platform, at or near the outer perimeter of the platform, so that the liquid will flow into the apertures instead of flowing over the device sidewall. For example, the apertures may ring the platform between the area where the appliance will be set and the sidewall of the device.

In certain embodiments, the aperture(s) are provided all or substantially all the way around the outer perimeter of the platform, so that liquid reaches the aperture(s) prior to reaching the outermost extent of the top side of the device and will flow into the aperture(s) rather than flowing over the top edge of the device. In such embodiments, the liquid falls into the aperture(s) before it can reach the sidewall. Certain of these embodiments may comprise a rim upending around part or all of the sidewall of the device, but such a rim is typically not necessary due to the aperture(s) surround all or substantially all of the platform. Such aperture(s) may also serve as pour spout(s) at or near the sidewall of the device, to enhance the efficiency and safety of emptying the device.

As mentioned above, one or more pour spouts are desired in certain embodiments for safe and efficient emptying of the liquid from the device, for example, upon carrying the device to a sink or other disposal area. The pour spout(s) are preferably at the edge of the platform, or in an upper region of a sidewall of the device/container. If provided lower on the device, for example, midway down the sidewall of the device/container, a plug is preferably provided.

When the invented device is placed, or integrally provided, beneath a small appliance (for example, an electrical appliance such as a coffee maker, or a drinking water filter carafe/reservoir), that operates by running liquid through it, and when a malfunction or breakage occurs causing a substantial amount of liquid to overflow, the overflowing liquid is captured and contained. This is preferably done by the process of liquid remaining on the upper platform surface until it drains into one or more of the upper platform apertures, which apertures are in fluid communication with the interior volume, or “interior reservoir” of the container. As discussed above, this process may be enhanced or encouraged by barrier(s) to the flow of liquid over the sidewall of the device and/or directing means.

The invented device is preferably removeable from beneath the appliance and carried to an appropriate place to empty the contents. Thus, the device may be separable from the appliance by virtue of the device being a separate unit that has no attachments or connections between the device and the appliance, except that the appliance rests on the device. Or, the device may be separable but may cooperate with the appliance by being latchable/lockable to the appliance, and, likewise, unlatchable and unlockable for separation of the device from the appliance. For example, the device may be connected by a latch or lock system to the base of the small appliance, but removable when the reservoir is due for emptying. This connection may be a slide-on, snap-on, pivot latch-on, slide-latch-on, or other connections. This way, the small appliance may be moved and used with the platform/container device attached, but said device may be removed without spilling and splashing when needed.

The device may be sold separate from any appliance, with a shape and size that is either adapted for a specific appliance or group of small appliances, or for a “universal fit” to many small appliances. Alternatively, the device may be provided with the small appliance at the point of sale, for example, for simple resting of the appliance on the device or with matched/mating latch/lock adaptations of the device and appliance.

Alternatively, the device may be designed as a portion of the appliance. For example, the platform of the device may be provided as the support surface on which the carafe sets during the brew cycle, and the container may be a drawer or latched reservoir beneath said support surface that is slidable/movable for removal and emptying. Such embodiments would typically be sold as an appliance plus device unit, in the form of appliance with a reservoir drawer, for example.

Depending on the amount of liquid overflow, the container may have a full interior reservoir or partially-full interior reservoir, but said container is preferably adapted to be easily-emptied in either situation. For example, the container sits beneath the coffee maker and collects the overflow, and preferably but not necessarily after it cools down, can be safely carried to the sink for emptying. During carrying of the container and emptying, the preferred wall structure, depth of the container, and small amount of aperture surface area make spills and splashes unlikely.

By catching liquid before it reaches the countertop, cabinets, desk, floor, etc., the container saves injury, damage, and frustration. Because all of the liquid is typically captured by the container, and because it is so easy and safe to empty, the container solves the situation with very little clean-up effort.

### BRIEF DESCRIPTION OF THE DRAWINGS

FIG. 1 is a front perspective view of an example coffee maker resting on top of one embodiment of the invented device, wherein the device extends underneath, and beyond the outer horizontal extremities of, the coffee maker on all sides of the coffee maker, and wherein the coffee maker is unattached to the device and may be easily lifted off of the device.

FIG. 2 is a front, top, perspective view of the device of FIG. 1, with the coffee maker removed, wherein one may see the slit-style apertures at or near the center region of the platform and the apertures at the corners of the platform.

FIG. 3 is a top, view of the device of FIGS. 1 and 2, with the device rotated so that the right side is facing downward toward the bottom of the paper.

FIG. 4 is a right side, cross-sectional view of the device of FIGS. 1-3, viewed along the line 4-4 in FIG. 3.

FIG. 5 is a front, top, perspective view of the device of FIGS. 1-4, with example interior walls shown in dashed lines.

FIG. 6 is an alternative embodiment of the invented device, which is a triangular version for fitting into a corner space on a countertop, cabinet, or table.

FIG. 7 is an alternative embodiment of the invented device, wherein the front wall of the device is curved.

FIG. 8 is an alternative embodiment of the invented device, wherein a device such as the embodiment shown in FIG. 1-5 is positioned atop a storage drawer unit.

FIG. 9 is an alternative embodiment of the invented device, wherein the apertures comprise several round holes in the platform surface and rounded corner apertures.

FIG. 10 is an alternative embodiment of the invented device, wherein the slit-apertures are near the center of the platform and grooves/troughs are provide to help direct overflow liquid to the slit-apertures. The groove/troughs are recesses, rather than apertures, and therefore do not extend all the way through the platform wall.

FIG. 11 is an alternative embodiment of the invented device, wherein the slit-apertures are near the center of the platform and the platform has a concave region to help direct overflow liquid to the slit-apertures.

FIG. 12 is an alternative embodiment of the invented device, wherein the triangular platform has grooves/troughs connecting to the apertures near the center of the platform to help direct overflow liquid.

FIGS. 13 and 14 are cross-sectional views of an alternative embodiment of the invented device, with a small appliance attached to the device by a sliding connection and pivoting latch system. This connection system is one, but not the only, embodiment of a device according to the invention that may be sold as a portion of the small appliance, but may be removed for emptying.

FIG. 15 is a perspective view of another embodiment of the invented device, which comprises an aperture all the way around the outer perimeter of the platform and two latches for holding the removable platform on the container. The platform is shown in broken lines, for ease of seeing the structure underneath the platform.

FIG. 16 is a top view of the embodiment of FIG. 15. The platform is shown in broken lines, for ease of seeing the structure underneath the platform.

FIG. 17 is a cross-sectional view of the embodiment of FIG. 15, viewed along the line 17-17 in FIG. 16. This cross-section cuts through two ledges that support the bottom surface of the platform, in a region wherein liquid will flow down through the aperture onto the ledges and from the ledges downward into the container reservoir.

FIG. 17A is a cross-sectional view of the embodiment of FIG. 15, viewed along the line 17A-17A in FIG. 16. This cross-section cuts through the device in a region between the ledges that support the platform, wherein liquid will flow down through the aperture and directly into the container rather than first flowing onto support ledges.

FIG. 18 is a perspective view of another embodiment of the invented device, which comprises an aperture substantially all the way around the outer perimeter of the platform, wherein the ledges supporting the platform are stepped ledges that hold the platform upper surface at the same, or generally the same, level as the top edge surface of the sidewall and that center the platform relative to the container. The platform is shown in broken lines, for ease of seeing the structure underneath the platform.

FIG. 19 is a top view of the embodiment of FIG. 18. The platform is shown in broken lines, for ease of seeing the structure underneath the platform.

FIG. 20 is a cross-sectional view of the embodiment of FIG. 19, viewed along the line 20-20 in FIG. 19. This cross-section cuts through two of said ledges that support and center the platform.

FIG. 20A is a cross-sectional view of the embodiment of FIG. 19, viewed along the line 20A-20A in FIG. 19. This cross-section cuts through the device between the ledges, in a region wherein liquid will tend to flow down through the apertures in this area and into the container rather than across the top surfaces of the ledges. The platform is shown in broken lines, for ease of seeing the structure underneath the platform.

FIG. 21 is another embodiment of the invented device, wherein an aperture extends all the way around the outer perimeter of the platform and wherein interior posts support the platform. The platform is shown in broken lines, for ease of seeing the structure underneath the platform.

FIG. 22 is a top view of the embodiment of FIG. 21.

FIG. 23 is a cross-sectional view of the embodiment of FIG. 21, viewed along the line 23-23 in FIG. 22. This view shows to best advantage how the platform may removably snap onto one or more (here, two) of the posts.

FIG. 24 is a perspective view of another embodiment of the invention comprising rings of central apertures in the platform and a corner spout aperture formed by lowering the sidewall of the device.

FIG. 24A is a perspective view of another embodiment of the invention comprising a corner spout aperture formed by lowering the sidewall of the device, wherein this device comprises a platform with a concave portion and a single central aperture.

FIG. 25 is a perspective view of another embodiment of the invention comprising rings of central apertures in the platform and a spout aperture formed by lowering the sidewall of the device at an end of the device.

FIG. 25A is a perspective view of another embodiment of the invention comprising a spout aperture formed by lowering the end sidewall of the device, wherein this device comprises a concave platform with a single central aperture.

FIG. 25B is a perspective view of another embodiment of the invention, similar to that in FIG. 25A except that the spout aperture in the end sidewall is replaces with a hole lower in the end sidewall provided with a plug.

FIG. 26 is a perspective view of another embodiment of the invention, similar to the embodiments of FIGS. 24A and 25A and B except that this embodiment does not comprises any sidewall aperture.

FIG. 27 is a perspective view of another embodiment of the invention, similar to the embodiments of FIG. 26 except comprising two central apertures in the concave portion of the platform.

FIG. 28 is a top view of the embodiment of FIG. 27.

FIG. 28A is a cross-section view of the embodiment of FIGS. 27 and 28 viewed along the line 28A-28A in FIG. 28.

FIG. 29 is a perspective view of another embodiment of the invented device that comprises a network of central apertures and grooves/channels connecting the central apertures, to direct liquid to the apertures for capture in the interior reservoir.

FIG. 30 is a top view of the embodiment of FIG. 29.

FIG. 31 is a cross-sectional view of the embodiment of FIG. 29, viewed along the line 31-31 in FIG. 30. This view shows that the grooves/channels are recesses that do not extend all the way through the platform.

FIGS. 32-35 are perspective and top views of alternative embodiments of platforms that each comprise grooves/channels and a central aperture for control and capture of overflowing/leaking liquid.

FIGS. 36 and 37 are perspective views of alternative embodiments of platforms, a rectangular and an oval platform respectively, each having a stepped upper surface and a central slit aperture for control and capture of overflowing/leaking liquid.

FIGS. 38, and FIGS. 39 and 40, show alternative embodiments of platforms, a circular and a triangular platform respectively, that are entirely or substantially entirely concave and that each have a central aperture.

FIG. 41 portrays a device-plus-coffee-maker assembly, wherein the device is the embodiment of FIG. 25, and wherein the platform is substantially larger than the coffee maker and the coffee maker is set so that overflowing/leaking liquid will fall into one or more of the central apertures.

FIG. 41A is a top view of the embodiment shown in FIG. 41, wherein the coffee maker is removed but its footprint is shown in dashed lines.

FIG. 42 portrays an alternative embodiment wherein certain features of the invention are provided in a beverage maker, by the surface(s) holding a beverage carafe (not shown in this view) being perforated for draining overflowing/leaking liquid into a drawer-style container/reservoir underneath the carafe-installation zone.

### DETAILED DESCRIPTION

The preferred platform and container device, for overflowing liquid from a small appliance, comprises a structurally-sound horizontal upper platform surface with one or more apertures for liquid flow into the interior reservoir of the device. In certain embodiments, said aperture(s) are minimal, for example, representing (that is, covering or amounting to) 1-10% percent of the upper surface area of the upper platform, and, more preferably, 2-7% of the upper surface area. This way, the platform surface may be strong-enough to support a small appliance, and closed-enough at its top to prevent splashing and spills when the device is carried to a sink or other location for emptying, but the overflowing liquid still flows through said apertures instead of overflowing the device. In such embodiments wherein the aperture(s) surface area is minimal, barrier(s) and/or directing means may be provided to control and/or direct liquid flow into the aperture(s) so that it doesn't overflow the device.

In certain embodiments, and especially in those wherein no barrier and directing means are provided to direct the flow to the aperture(s), it is desirable that the number and/or placement of the aperture(s) and the size and placement of the device relative to the appliance be chosen so that the liquid flows to the aperture(s) before and instead of flowing over the edge of the device. For example, the device may be substantially larger than the appliance, extending underneath and all the way around the appliance beyond the horizontal extremities of the appliance.

For example, the aperture(s) may form a larger portion of the upper surface area of the platform, for example, representing (that is, covering or amounting to) more than 10 percent, or more preferably more than 10 and up to 95 percent, or 30-80 percent, or 30-50 percent of the upper surface area of the upper platform.

Certain embodiments comprise an upper platform, and a container beneath the platform that comprises a generally or totally flat, horizontal base portion, and sidewall(s) that extend(s) vertically upward from the base to define the liquid-retaining interior reservoir. The sidewall(s), or other structure such as ledges or pillars, for example, may structurally support the platform. As discussed in the Background section of this disclosure, when a small appliance placed on the platform overflows or leaks, the overflowing or leaking liquids are captured and contained. Such overflowing or leaking liquid can be substantial, for example, several cups, pints, or quarts of liquid from a coffee maker or water carafe, and the liquid may be hot, damaging, and/or staining. Therefore, adaptations are made preferably for multiple functions, specifically, the effective and safe capture and also the effective and safe disposal of this substantial amount of liquid. These functions and adaptations are typically different from those for simple capture of drips and small splashes and spills, for example, different from the simple perforated or mesh platform typically provided underneath the cup/portafilter of an espresso machine.

The functions and adaptations of the preferred device may be described as providing a reservoir that must remain structurally-sound and liquid-tight when catching an overflow of extremely hot temperature liquid, and must hold more than the capacity of the appliance being used. The platform may or may not have a small vertical rim around the top to contain liquid from running over the top of the platform. However, preferably, and especially if a rim is not provided, the topography of the platform may allow for the liquid to drain toward the apertures in the surface and into the reservoir. Slanted, concave, or stepped portions and/or recesses or channels may be provided in the upper platform surface to “direct” or “guide” the liquid to the apertures. The apertures may not have raised edges/lips, so that the majority of the upper platform surface is at the same level or slightly above the edges of the apertures, thus, encouraging or at least not hindering liquid flow into apertures and hence into the interior reservoir.

Added structural support within interior reservoir may be needed to maintain the strength and integrity of the platform, especially with extremely hot liquids. For example, a vertical wall(s), pillars, or other supports for the upper platform, at or near the center region of the upper platform, may be used. These vertical walls/pillars/supports, however, should not be long or large enough to create baffles or barriers inside the interior reservoir that interfere with quick and smooth flow of liquid inside the interior reservoir, and preferably to the corner apertures, for emptying the reservoir. Thus, it is preferred that there are no interior walls, drawers, bins, or inserts that extend all the way across any dimension of the interior of the reservoir. For example, it is preferred that there are no walls, drawers, bins, or inserts that extend across the entire or substantially the entire length of the interior reservoir, or across the entire or substantially the entire width of the interior reservoir.

Materials to produce the platform and container device must have structural integrity to withstand extreme temperatures and remain structurally sound to withstand the weight of the appliance under high-temperature and wet conditions. The container may be made of manufactured or molded Plexiglas™, plastic(s), metal(s), or any material(s) that is capable of maintaining the needed integrity.

The upper platform may be integral with, permanently secured/fixed to the side walls of rim of the reservoir portion and/or to ledges, pillars, or other structure of the device, and/or may be removable for cleaning of the interior of the container. Removable platforms, however, may require a latch, snap-in connection, slide-out connection, or other means to prevent the platform from sliding off or falling off/away from the reservoir when being used, carried and/or emptied. An important feature is the safety of use and emptying of the device, so it is preferred that said safety be paramount as opposed to quick cleaning of the interior reservoir. Soap and/or bleach may be poured through said apertures for soaking of the container, followed by draining of the container without opening the container; thus, certain embodiments are cleanable/sterilizable without having a removable platform and without being otherwise adapted for disassembly. Other opening means may be used to clean the inside of the device, for example, several latches (not shown), which retain the upper platform over the reservoir, may be pivoted or snapped away from the upper platform to allow removal of the platform and exposure of the interior surfaces of the reservoir. Or, a removable but latchable “door” or other portion of the platform may be provided in the upper platform to allow better cleaning. Having a removable door/portion provided in the platform, or having the entire platform be removable would be preferable to having another portion of the container being openable or removable, as the latter option would make sealing the container more difficult, and the container would more likely leak potentially dangerously-hot fluid during overflow or carrying of the device. Therefore, the platform may be permanently secured/affixed to the reservoir, or removable but preferably latchable or lockable.

It is preferred that emptying of the container be done by retaining the platform in place (by permanent connection and/or latching or locking to the walls of the reservoir), and that the container be emptied by draining the liquid through one or more spout apertures into an appropriate object or place, such as a sink or sewer drain. In preferred embodiments, spout aperture(s) is/are provided so that water will flow substantially unimpeded out through the spout and pour neatly into a sink or basin, or other container, rather than splashing or gurgling along adjacent surfaces of the device. The preferred locations for said spout aperture(s) are at or near the outer extremity of the device, for example, at one or more corners of the platform/container or at other locations at or near the outer perimeter of the platform, at the sidewall, or immediately adjacent to the sidewall. A spout aperture immediately adjacent to the sidewall may be formed by a notch, cut, scallop or other opening at the edge of the platform so that the spout aperture is immediately adjacent to the sidewall. In cases wherein the sidewall has an upending rim above the level of the platform, the rim immediately adjacent to the spout aperture may serve as a portion of the “spout” in that the rim surface will further direct the liquid to stream smoothly out and away from the device for disposal.

Alternatively, the spout aperture may be formed in the sidewall, for example, a portion of the sidewall itself may be lowered to form the spout aperture. Or, in certain embodiments, a hole is provided in the sidewall and plugged.

After the device is carried with a full or nearly-full reservoir to an appropriate place to empty the contents, the device is preferably simply tilted to place a selected spout aperture lower than the main portion of the reservoir, and the liquid will drain out of the reservoir in a controlled manner through the spout aperture. For example, when the device comprises a corner or an oblong/oval end that has a spout aperture, it may be easy to lower that corner/end for flow of the contained liquid to that corner/end and then neat and predictable draining of the captured liquid through that spout aperture. Other spout apertures may be effective as well, with the apertures being preferably designed so that draining is fairly predictable and neat.

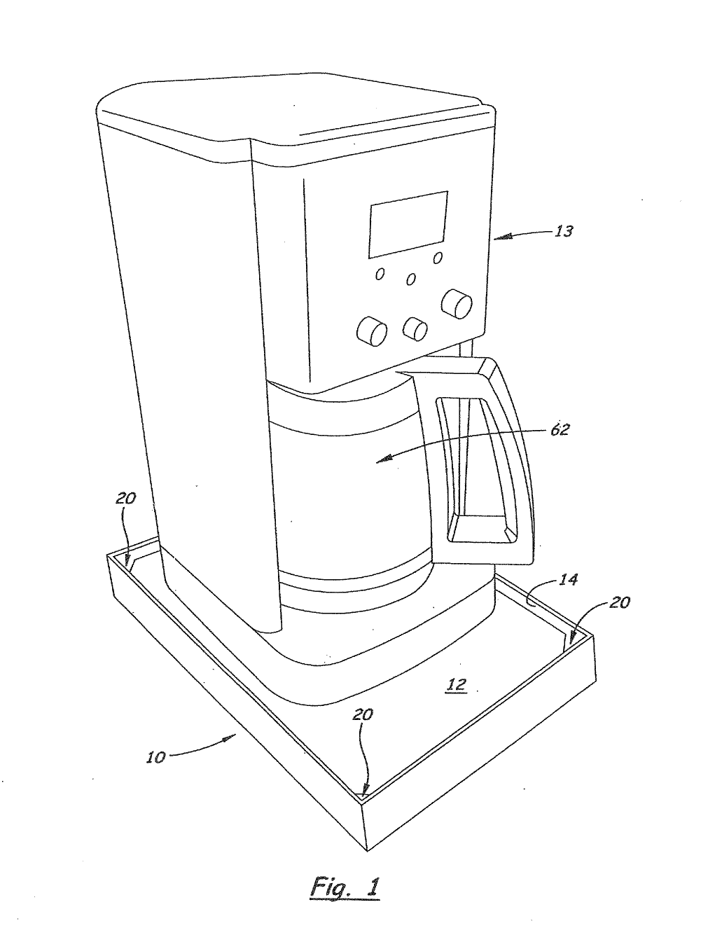

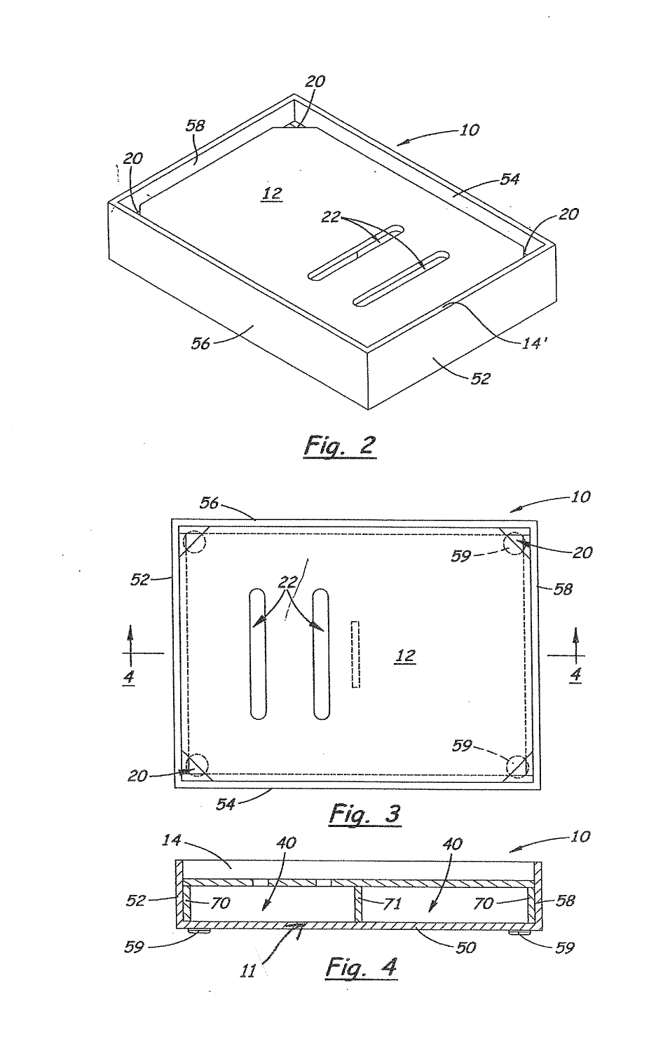

In certain embodiments, the footprint of the device must be larger than the footprint of the appliance to catch the overflow and the majority of splash. The container may have feet on the bottom to keep condensation and heat from touching the surface below to reduce damage to that surface. It may be noted that the small appliance will also typically have feet/pads on the appliance bottom surface, and this will provide room between the bottom surface of the appliance and the upper platform to allow the overflowing liquid to flow along the upper platform to the apertures. This way, even in embodiments wherein the appliance covers some or all of the apertures from the user's vision, the liquid will flow to the apertures. See, for example, FIGS. 1 and 2, wherein the slit-style apertures near the middle region of the upper platform are covered by the coffee maker. In this embodiment, it will be understood that the liquid may flow to said slit-style apertures, by flowing underneath the coffee maker, and/or to the corner apertures that are not underneath the coffee maker.

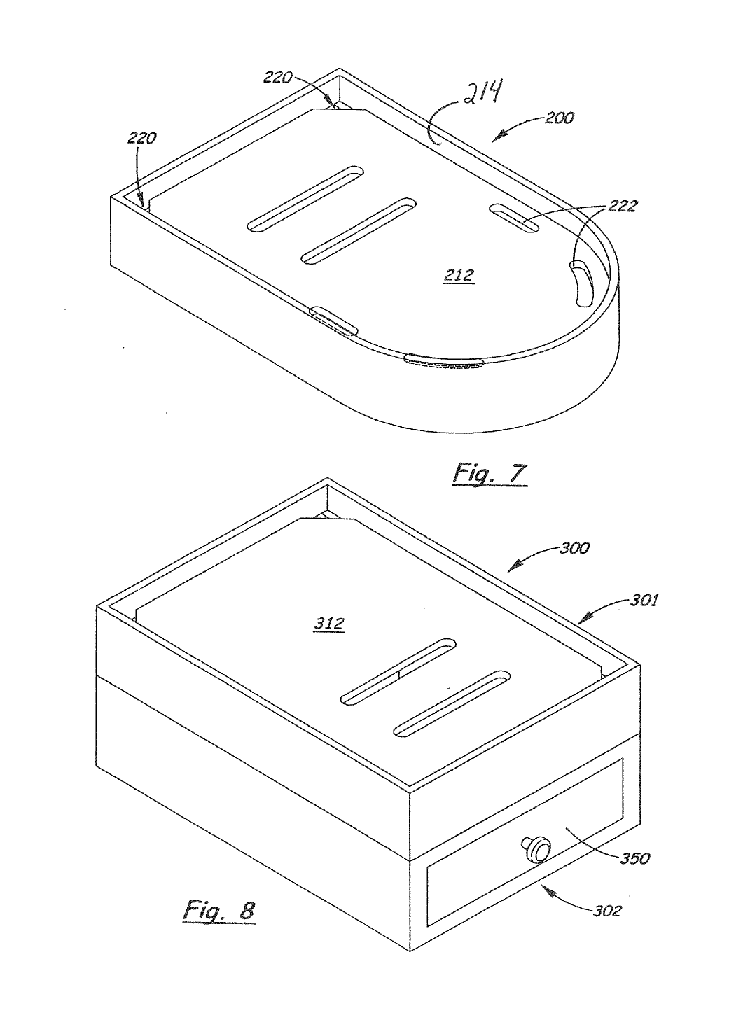

Sizes, shapes and colors may vary and the platform could be attached to the reservoir permanently as one unit, or removable/separate as discussed above. Added accessories could be added such as stacking components with a storage area or drawer to keep often used items such as filters, spoons, straws, sugar packets, etc. See, for example, FIG. 8, described in more detail below.

The device could also be incorporated into an appliance as an original equipment manufacture (OEM) feature, wherein the device would be at least large enough to contain the entire liquid contents of the carafe, and more preferably of the entire appliance. Preferably, the container portion would be removable from the appliance and would be closed enough to be safe during carrying and emptying. In prior art coffee and espresso makers having small trays with screened or slotted covers, the covers are substantially open (lots of slits or screen holes), and the covers easily allow spills and splashes if the appliance of the tray is carried. Also, said trays typically have such low volumes that they only can contain drips or small spills, but not the entire liquid contents of the appliance. Also, said trays are typically at the front of the appliance only, for being underneath a cup and/or portafilter, while the preferred embodiments of the invented device extend all the way around, and out beyond, the entire bottom/base of the small appliance.

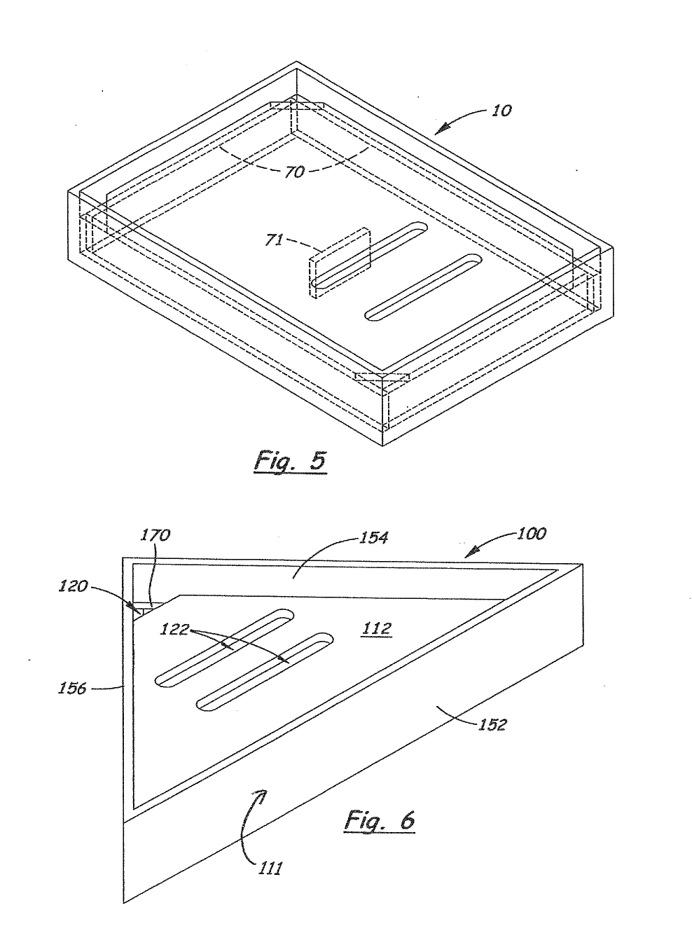

Referring specifically to the Figures, there are shown some, but not all, embodiments of the invented device. In FIG. 1, device 10 is shown under an appliance 13, and in FIGS. 2-5 removed from below the appliance. The device 10 comprises a container 11 (see FIG. 5) comprising and/or supporting a structurally-sound and generally horizontal upper platform 12 for supporting a small appliance 13. The device 10 has a larger footprint than the appliance 13 so that it extends under the entire appliance 13 and extends horizontally outward in all directions beyond the outer horizontal perimeter of the appliance 13. The platform 12 is an example of a platform embodiment that is a substantially-closed, substantially-solid surface containing minimal apertures. By substantially-closed, substantially-solid surface, it is meant that most of platform surface is solid and continuous, without apertures. The platform 12 is preferably not a screen, mesh, grill, or otherwise majorly-perforated. Preferably, the platform 12 has less than 10% of its surface area being apertures, more preferably, 1-10%, and most preferably 2-7% of its surface area being apertures. Therefore, typically 90-99%, and more preferably 93-98% of the surface area within the preferred rim 14 is solid and continuous.

The apertures preferably comprise apertures at the sidewall of the device 10. These “corner apertures” 20 are provided in the corners of the rectangular device 10, by notches being formed in the edge of the platform 12. Their location in the corners of the device 10, and their closeness to the upending rim 14 of the sidewall (which provides protruding surfaces serving as the spout walls), make apertures 20 particularly effective as spout apertures. For example, once carried to a disposal site, the device 10 may be tipped to lower one or more of the corners to be the lowest portion of the device, so that the contained liquid will flow out of the corner aperture(s) 20 as it poured from a spout. The liquid will tend to flow out and away from the spout aperture and the rim surfaces helping to form the “spout”, without the liquid flowing over any of, or a substantial amount of, the platform. Also, this way, the liquid will be very likely to not contact the user's fingers/hand; thus, cooling of the liquid before emptying is preferred but not necessarily required.

Both the corner apertures 20, that is, one in each corner of the rectangular device 10, and the two central apertures 22, receive overflow, spilled or leaked liquid from the appliance 13 into the liquid-tight reservoir 40. The two central apertures 22 are slits in the platform in the front half of the platform 12, but distanced from the rim 14 front portion 14′. Platform 12 may be described, therefore, as a generally rectangular plate with its corners removed to form apertures 20, and with one or more elongated apertures at or near its center.

Alternatively, one may understand from this disclosure that certain embodiments of the platform may have only corner/perimeter apertures, which may also serve as spout apertures, but not central apertures. The upending rim 14 may serve to dam the liquid, preventing it from overflowing the device and also raising the liquid on the platform to a level wherein it will tend to flow by gravity into the few corner/perimeter apertures even though the corner/perimeter apertures are distanced from the center of the device. Alternatively, but less preferably, certain embodiments may have central apertures, but not corner/perimeter apertures, as this may allow draining into the container reservoir and also emptying through the central apertures. Emptying through the central apertures is not preferred, however, as the “pour spout” effect may be lost in certain embodiments, and the emptying process may be messier and/or not as safe. If the platform is easily removable, certain embodiments may be provided with only central apertures, but the platform may be removed for emptying.

The reservoir 40 is defined by walls forming a generally rectangular box of which the platform 12 is the top wall. Said walls comprise the top wall, which is platform 12), generally-flat (or in certain embodiments completely-flat) horizontal base 50 (bottom wall), and a sidewall comprising front wall 52, right wall 54, left wall 56 and rear wall 58. The sidewall (52, 54, 56, 58) extends vertically from the base 50 to define the liquid retaining space (reservoir 40), and structurally support the platform 12. The device 10 may have feet 59 on the bottom to keep condensation and heat from touching the surface below to reduce damage to that surface.

The reservoir must remain structurally sound and liquid-tight when catching the overflow of extremely hot temperatures (for example, 180-212 degrees F.), for example, and must hold more than the capacity of the appliance being used. Therefore, the preferred container 10 should hold in its reservoir 40 more than 6 cups, 8 cups, and 12 cups of liquid, for 6-cup, 8-cup, and 12-cup coffee makers, respectively. For example, the container 10 may hold in its reservoir 20-300 percent, 20-150 percent larger, 20-100 percent larger, or 20-50 percent more liquid, than the maximum liquid capacity of the appliance during normal use.

Overflowing liquids from a coffee maker (small appliance 13), for example, those missing the intended carafe 62, may flow onto the platform 12 and flow to and down through one or more of the apertures 20, 22, to be captured and contained in the reservoir 40. The preferred rim 14 may extend, for example, vertically about ¼-½ inch above the top surface of the platform 12, to prevent overflow off the device 10, for example, if the device 10 is on an uneven surface or if the platform is so flat that some liquid runs to the edge of the device. Instead of, or in addition to the rim 14, the topography of the platform may direct the liquid to drain toward at least some of the apertures or all the apertures, for example, by slightly concave top surface areas of the platform “leading downhill” to the apertures. A benefit of the corner apertures 20, or other apertures at the outer perimeter of the platform, is that, if the device 10 is on a slanted surface, the liquid will naturally flow to one or more corners.

Materials may be selected, and/or structural supports may be provided within the reservoir, to maintain the strength and integrity of the platform for safe and reliable support of the weight of the appliance. This is especially important given the extremely hot liquids that tend to flow onto and into the device 10. The walls and platform of the device and/or supports may be made of manufactured or molded Plexiglas™, plastic, metal, or any material(s) that is/are liquid-proof and capable of maintaining the needed integrity. Supports 70, 71 are shown to best advantage in FIG. 4, where supports 70 are supplements to the sidewall at or near the outer perimeter of the platform. Supports 70 may be several support walls, or preferably a continuous wall, inside relative to, and shorter than, the outer sidewall. Supports 70 preferably upends adjacent to, and preferably touches and is connected to, the sidewall. This way, the support(s) 70 provides extra structural integrity, and the support(s) 70 top edge also serves as connection and/or liquid-seal means and support for the platform 12. The platform 12 may also, or instead, be connected and/or liquid-sealed to the sidewall (walls 52, 54, 56, 58) rather than the supports 70.

Additionally, support 71 is located at or near the center of the reservoir 40, and may act as a central support pillar in the area where the appliance may be centered. As will be understood from this description, the platform in certain embodiments may be liquid-sealed all around the outer perimeter of the platform, except at apertures, if any, that at are the outer perimeter (such as corner apertures 20).

As shown in FIG. 1, the footprint of the device 10, and the surface area of the platform, should be larger than the footprint of the appliance to catch the overflow and leaks and at least the majority of the splash. How much larger the device footprint and the platform surface area are compared to the appliance footprint may be determined in certain embodiments by whether the device comprises barrier and/or directing means for controlling liquid flow into the aperture(s). In certain embodiments, the upper surface of the platform 12 is at least 20 percent larger (for example, 20-300 percent, 20-150 percent, 20-100 percent, or 20-50 percent larger) than the appliance at its horizontally-outermost extremity. For example, if the coffee grounds cone extends farther than the carafe, it is preferred to have the device be at least 20 percent larger than footprint of the appliance as measured in a horizontal plane at the largest part of said coffee grounds cone region. In FIG. 1, the bottom base of the coffee maker appears to have the largest footprint of the coffee maker, so the device 10 is preferably at least 20 percent larger in footprint than the coffee maker bottom base.

FIG. 6 portrays an alternative embodiment of the device 100 illustrating one of many alternative shapes for the device. Device 100 has a generally triangular container 111, and generally triangular platform 112 providing an upper support surface for an appliance. The generally triangular sidewall comprises a front wall 152, a right wall 154, and a left wall 156. Support wall(s) 170 may be seen below the rear aperture 120 as a support member(s) to hold up and/or connect and/or liquid-seal to the platform 112. In addition, or instead, the platform 112 may be connected to and/or liquid-sealed to the sidewall (152, 154, 156) except at the corner apertures 120.

Corner apertures 120 are provided in preferably all three corners of the device (with only the rear one being visible in FIG. 6), for receiving overflowing liquid and preferably also for emptying the liquid as discussed above. Device 100 also has two generally-centrally-located slit apertures 122, which may receive overflowing liquid as discussed earlier in this document, and which may less preferably also be used for emptying liquid.

FIG. 7 portrays an alternative embodiment, device 200, featuring another example of an alternative shape. Curved-front device 200 is has a rectangular rear portion, and a curved, generally-semi-circular front portion. Platform 212 is therefore rectangular at its rear, and has two corners removed to form apertures 220 for liquid-receiving and preferably also for dispensing liquid; hence, one may call these apertures 220 “draining” or “spout” apertures, as discussed above. Multiple elongated, curved slit/slot apertures 222 are located near the generally circular front of the device, and may serve for receiving and/or dispensing liquid. Apertures 222 are near, but not exactly at, the upending rim of the device 200, and so may be effective in certain embodiments in liquid dispensing/draining. The distance from the apertures 222 to the upending rim 214 may result in some spreading-out (along the rim) of the draining liquid after it flows out of the apertures 222, which may result in a wider and/or slightly less controllable spout/spray of water into the sink or other disposal area. Platform 212 also has two optional parallel, elongated slit-style apertures (not numbered) at or near the center of the platform.

FIG. 8 is a rectangular device 300 with an upper reservoir portion (container 301) and a lower drawer portion 302, in a stackable configuration. The upper container 301, with its platform 312, is the same or similar to the device 10 shown in FIG. 1-5. Container 301 is set on top of drawer portion 302, preferably with some adaptation (not shown) of the sidewall and/or bottom wall of portion 301, and/or the sidewall and/or upper wall of the drawer portion 302, to allow the container and drawer portions to nest or mate to provide the appearance and stability of a single unit. The container 301 is preferably removable simply by lifting it up, but, less preferably, a latch or lock (not shown) may be unlatched or unlocked to allow separation of the two portions 301, 302. If the upper portion 301 is easily liftable off the lower portion, there will be little chance of spilling or splashing liquid out of the reservoir portion 302.

The lower drawer portion 302 may be described as a rectangular box with one drawer 350 that may be used for beverage accessories, utensils, napkins, creamer packets, filters, spoons, straws, sugar packets, etc. The drawer 350 may fill, when closed, the major portion of the interior of the lower portion 302. The lower drawer portion 302 may have feet, pads, or legs on its bottom, for example, for gripping or frictionally engaging the countertop, table or other surface upon which it is set. Alternatively, the lower portion may be substantially open at the front end, for example, which allows storage in an interior space of the lower portion, but without a drawer.

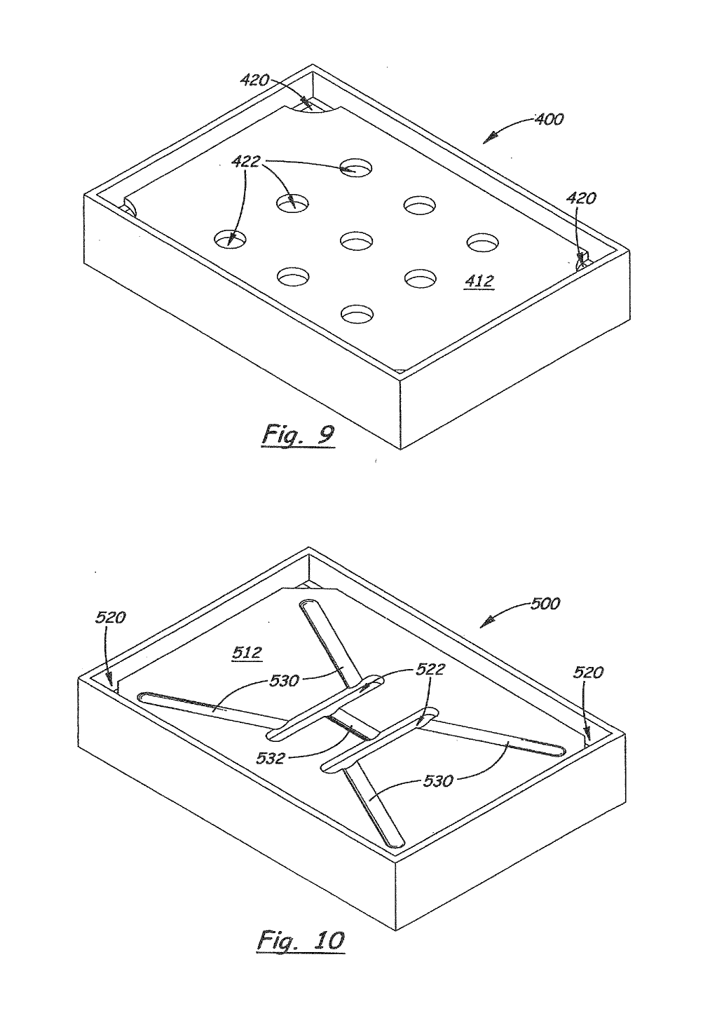

FIG. 9 illustrates a device 400 similar to the rectangular devices discussed previously, but with alternative apertures in the platform 412. The corner apertures 420 each have a curved edge, and the apertures 422 near the center of the device are round holes. This figure illustrates alternative apertures, but it will understood that other shapes and sizes of apertures may be used, including other shapes of apertures at or near the center of the platform (such as triangular, polygonal including square, rectangular and hexagon), apertures of various shapes in the region between the center of the platform and the outer perimeter of the platform (circular, slit, elongated, curved, polygon, for example), and other shapes and/or numbers of apertures at or near the corners or otherwise at or near the outer perimeter of the platform (circular, slit, elongated, curved, polygon, for example).

FIG. 10 illustrates one of several ways the platform may be topographically structured, curved or adapted to help guide/direct the overflowing/leaking liquid into the apertures. FIG. 10 shows an embodiment of the device 500 that has corner apertures 520 as discussed above, plus two slit-style apertures 522 near the center of the platform. These apertures 520, 522, as in the other holes/openings called “apertures” herein, go all the way through the platform wall, to fluidly communicate with the interior reservoir space. In addition, this device 500 illustrates one, but not the only, embodiment of grooves 530 that extend across the platform preferably from different directions to collect liquid, direct it toward, and “empty” the liquid into, the apertures 522. The grooves 530, and the groove 532 connecting the two apertures 522, are elongated recesses that will tend to act as receivers of the overflowing liquid, and to direct the liquid by virtue of the inner ends connecting, without obstacle or barrier to liquid flow, with apertures 522. For example, the edges of the apertures should be flush with the surrounding platform surface, rather than having raised edges. These grooves 530, 532, therefore, may assist gravity flow into the apertures.

Grooves may also be provided to direct flow into the corner apertures, but virtue of being recessed and connecting, without obstacles or barrier to liquid flow, to the corner apertures. The grooves leading to one or more apertures, including the central apertures and/or the corner apertures, may be beneficial in directing flow, while not increasing the percentage of apertures (openings, holes) in the platform, as an adaptation to prevent splashing and spilling during carrying and emptying the device. The grooves may have bottom-most surfaces that are slanted toward the apertures, to further encourage flow of overflow water by gravity to the apertures. This slanting may be minimal, for example, 1-5 millimeters drop from the highest end of the bottom surface of each groove to the edge of its respective aperture(s).

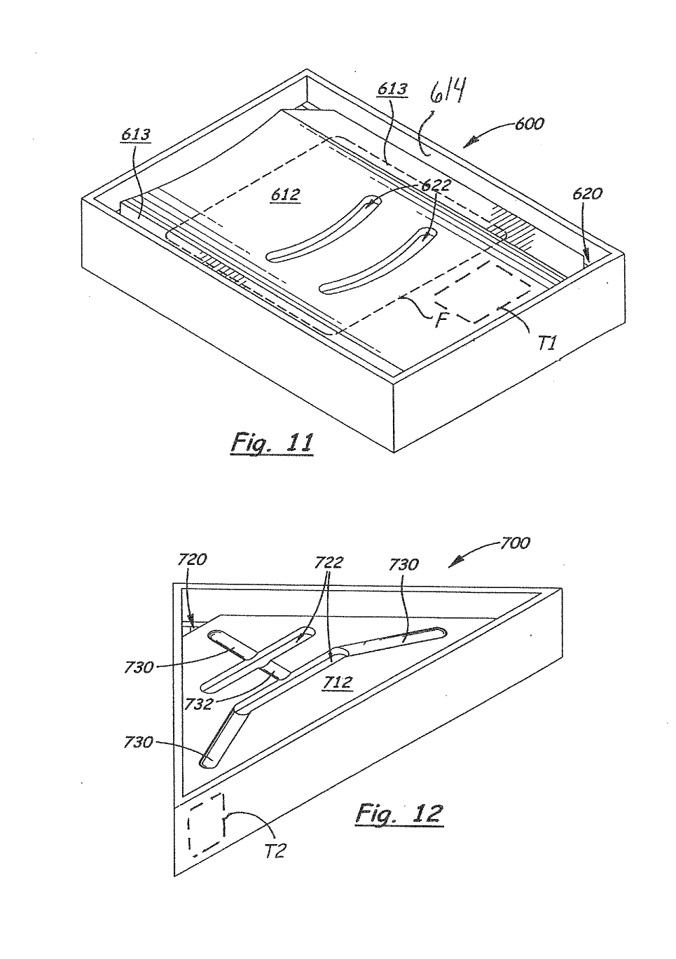

FIG. 11 illustrates an embodiment, device 600, featuring a platform 612 with corner apertures 620 plus a large region that is concave for draining overflow liquid to the apertures 622 at or near the center of the platform. The platform 612 is symmetrical on each side of its longitudinal centerline, wherein right and left horizontal, “flat” strips 613 abut and/or seal to the upending rim 614, and platform surface extends between these strips 613 and is concave so that the lowest portion of the platform in along the longitudinal centerline. Thus, the small appliance may rest on the platform, mainly or entirely on the horizontal strips 613 (which will be preferably parallel to the table or countertop surface on which the device rests), but the concave surface underneath the appliance will be efficient in catching and directing the overflow liquid to the apertures 622.

Note the example footprint F of the appliance in dashed lines on the platform, wherein the platform is much larger than the footprint of the appliance, and the appliance rests on the platform in a stable and safe manner due to the horizontal regions of the platform receiving the base of the appliance. Other portions, including smaller portions, of the platform may be concave (looking from above) or recessed, but with the preferred provision that, if there are multiple concavities/recesses, that they are connected to allow drainage from one to the other and to apertures through the platform. Alternatively, because of the symmetry of the right and left halves of the platform 612, certain embodiments of smaller appliances may rest only on the concave portion of the platform 612, and, because the concavity is not extreme and appliances typically have rubber/gripping feet, such a smaller appliance may rest stably and operate safely on the device 600.

FIG. 12 illustrates another embodiment of the device 700 that includes a platform 712 with corner apertures 720 and also slit-style apertures 722, plus grooves 730 leading to the apertures 722 and a groove 732 between the apertures 722. Note that, in this embodiment, one might extend the grooves 730 to fluidly communicate with the corner apertures 720 also, so the grooves could direct fluid to all apertures.

FIGS. 11 and 12 also illustrate some, but not the only, embodiments having transparent portions that may allow the user to see the level of liquid in the reservoir. For example, transparent or translucent portion T1, in dashed lines, allows the user to see into the FIG. 11 reservoir to see or estimate how full the reservoir is. Alternatively, transparent or translucent portion T2 in FIG. 12, in dashed lines, is an alternative approach, wherein a portion of a side wall of the reservoir allows the user to see or estimate how full the reservoir is. Alternatively, other “sight glass” features or means may be used, including larger portions of the device, or the entire device, being transparent or translucent. The device may be made of many different materials, therefore, including opaque, transparent, translucent, and a mixture of these, including plastics, metals, and composites.

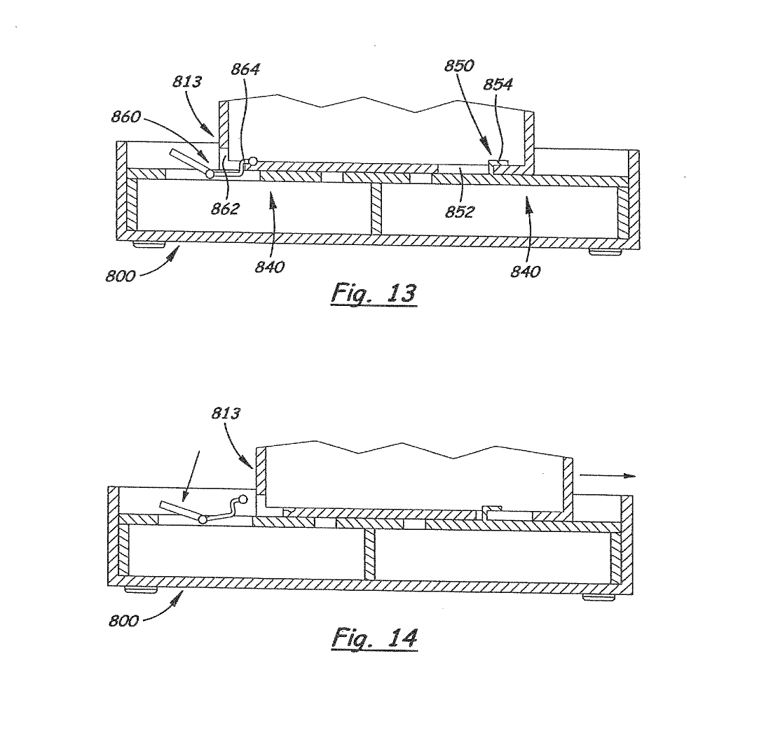

FIGS. 13 and 14 illustrate cross-sections of one, but not the only, embodiment of the device 800 that is sold with a small appliance 813, as a connected but removable portion of the appliance. The device 800 and appliance 813, for example a coffee maker, may be connected to each other for use until the device 800 needs to be emptied. One may see an embodiment of a connection between the two, in FIGS. 13 and 14, which comprises connection at two locations between the device and the appliance. The front connection 850 comprises a hook 854 extending up from the platform and being received in an aperture or recess 852 in the bottom surface of the base of the appliance. The hook 854 extends over an edge of the bottom wall of said base. The rear connection 860 comprises a pivotal latch with a latch end 864 that extends through an apertures/recess 862 in the base and that hooks over an edge of the base bottom wall. Thus, one may see the latched configuration in FIG. 13, wherein both the hook 854 and the latch end 864 (which may also be called a “hook”) are positioned to hold the base of the appliance and the device tightly together. This way, the appliance and platform/container device may be sold, used, and moved as a single unit. If liquid overflows, spills or drips, the latch 860 may be unlatched and the appliance may be slid off of the platform/container device, as shown in FIG. 14. The aperture/recess 852 is large enough to allow the sliding and then lifting of the appliance up off of the platform. Other latches, snap-connections, hooks and connection mechanisms may be used to temporarily connect the appliance to the device.

Other views of the embodiments in FIGS. 1-14 may be understood from the drawings and from the following comments. While not all the embodiments of the invention need to be symmetrical, the embodiments shown in FIGS. 1-14 are preferably symmetrical about their longitudinal vertical plane (from front to rear, along the centerline). So, while not all sides are shown, the right and left sides of the devices in FIGS. 1-14 may be understood to be minor-images. The bottom surfaces of the embodiments in FIGS. 1-14 are typically flat, planar, and solid (continuous), with feet optionally added at or near the corners, but other bottom surfaces may be effective, for example, with recesses or texture for strength, but preferably no apertures, holes for screws or rivets, or seams that could cause leaks. The upper reservoir portion of the embodiment of FIG. 8 is the same as that in FIGS. 1-5, except that the bottom surface may be adapted to nest or mate with the drawer portion, as discussed above.

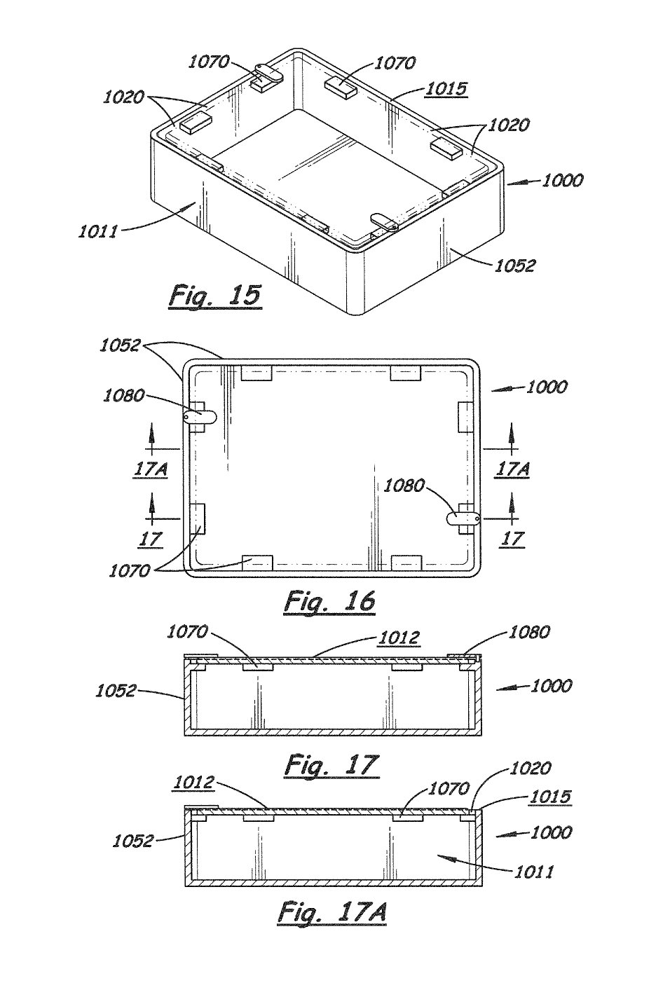

FIGS. 15-17A portray an embodiment, device 1000, that features only perimeter aperture(s), specifically, a perimeter aperture 1020 that extends all the way around the top of the device. In other words, the outermost edge of the platform 1012 is distanced from the sidewall 1052 of the container 1011, creating a gap (aperture 1020) all around the platform that will drain liquid from the platform into the reservoir of the container 1011. Multiple ledges 1070 are provided to support the platform 1012, wherein the top surface of the each ledge is below the level of the top surface of the platform, so that liquid falling onto a ledge 1070 will tend to flow down into the container reservoir. Thus, liquid that falls, leaks, splashed or overflows onto the platform 1012 will reach the aperture 1020 and flow into the container reservoir, either by flowing directly down through the aperture 1020, or by flowing onto a ledge 1070 and then into the reservoir. In other words, under normal circumstances, no liquid that reaches the platform top surface will overflow the device. Therefore, one may understand that no upending rim is provided in this embodiment for damming the liquid; the top surface 1015 of the sidewall of the container 1011 may be seen to be at the same level or slightly below the top surface of the platform 1012.

FIGS. 17 and 17A are cross-sections along the view lines shown in FIG. 16. FIG. 17 shows a cross-section through the device 1000 at a location wherein two ledges 1070 and one of the two pivotal latches 1080 are cut. FIG. 17A shows a cross-section at a location wherein no ledges and no latches are cut (both being behind the cut-line in the figure).

For embodiments where a latch or latches are provided, many different types, styles, and locations of latch(es) may be used. The latches 1080 in FIGS. 15-17A are one, but not the only, latch embodiment for holding the platform 1012 on the container 1011, until the user unlatches the platform, for example, for draining or cleaning. In certain embodiments, the weight of the appliance holds the platform in place on the container until removal of the appliance, after which the user may hold the platform in place, if needed, with his/her finger(s)/hand(s).

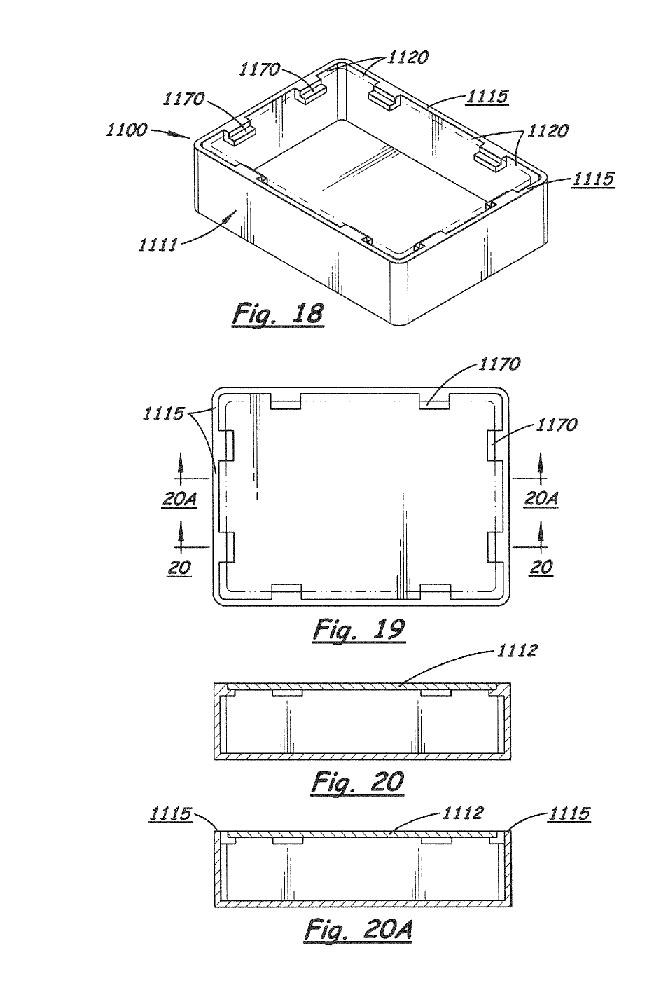

FIGS. 18-20A portray an embodiment, device 1100, that features only perimeter aperture(s), specifically, a perimeter aperture 1120 that extends all the way around the top of the device. The device 1100, including its container 1111 and the platform 1112, may be seen to be the same or very similar to the structure of device 1000, except that the support system for the platform 1120 is modified. Ledges 1170 are stepped ledges, each comprising a shoulder against which the platform rests. This way, the platform is supported and also substantially or entirely retained from horizontal movement relative to the ledges and sidewall. This way, platform 1112 remains centered relative to the sidewall, maintaining a consistent and desirable gap (aperture 1120) all around the edge of the platform.

Device 1100 does not include a latch for latching and unlatching the platform 1112 from its position on the container 1111. Gravity and appliance weight will keep the platform on the container during use underneath an appliance. The device 1100 may typically be moved, even full of liquid, without the platform sliding from its preferred position, assuming the device is held with the platform generally horizontal. More preferably, however, the user may press down on a portion(s) of the platform, to press it down against the ledges 1170, while the user carries and tips the device to empty the device. Alternatively, the platform may be secured/fixed to the ledges. Alternatively, a latch may be added.

In a similar manner as described for device 1000, the outermost edge of the platform 1112 of device 1100 is distanced from the sidewall of the container, creating a gap (aperture 1120) substantially all around the platform that will drain liquid from the platform into the reservoir of the container. As the top surface of the each ledge is shown as being about at the same level as the top surface of the platform, there may be a little liquid that falls on the ledges 1170 that may not tend to flow down into the container reservoir. To remedy this, however, the top surface of each ledge 1170 could be slanted slightly inward and/or could comprise a ridge at its outermost extremity to prevent liquid from running over the ledge to the outside surface of the sidewall. Thus, substantially all of the liquid (or all the liquid given slight modifications of the platform support) that falls, leaks, splashed or overflows onto the platform 1112 will reach the aperture 1120 and flow into the container reservoir. In other words, under normal circumstances, no liquid that reaches the platform top surface will overflow the device. Therefore, one may understand that no upending rim needs to be provided around the platform/device for damming the liquid. A slanted surface or a rim on only the ledges may further ensure complete liquid capture. The top surface 1115 of the sidewall of the container may be seen to be at the same level or slightly below the top surface of the platform 1112.

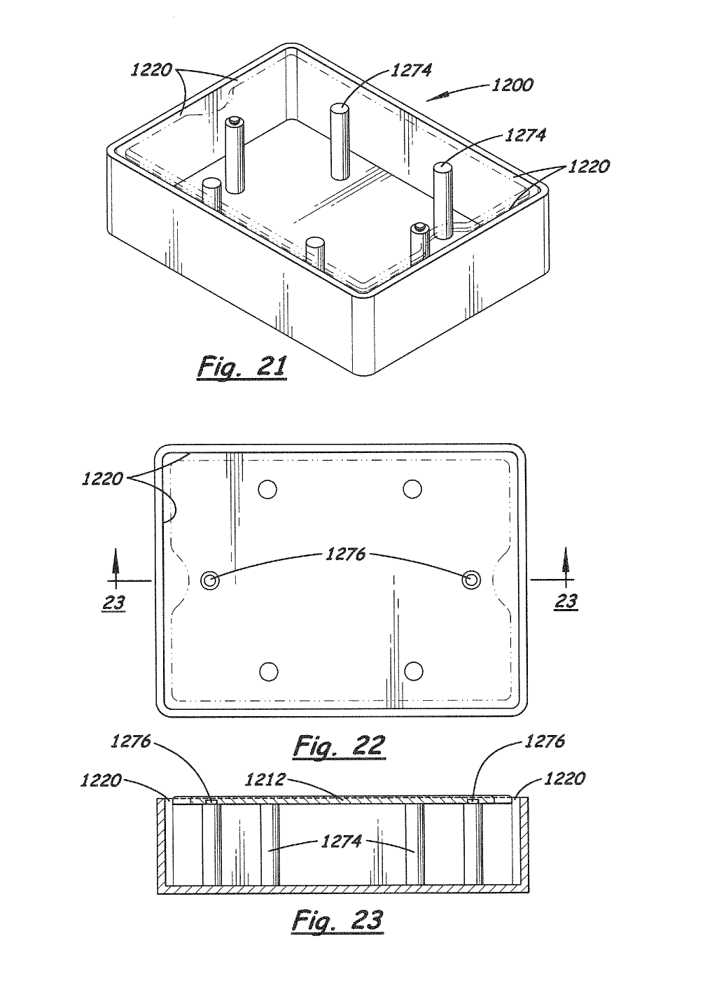

FIGS. 21-23 portray another alternative embodiment, device 1200, that features a perimeter aperture 1220 all the way around the platform 1212 and no upending rim for damming liquid. The platform 1212 is supported by structure inside the container reservoir. The supporting structure comprises pillars 1274 in the reservoir space rather than against or attached to the sidewall. One or more of the pillars 1274 (here, two) may latch to the platform, for example, by a snap-together connection 1276 between the pillar 1274 and the platform 1212. Thus, the aperture 1220 is maintained at a consistent and desirable gap, by virtue of the platform being connected to the pillar, preferably by a temporary, unlatched connection such as said snap-together connection 1276. One may note that the aperture 1220 at each end of the device comprises a scallop-shaped enlargement in the aperture 1220; this provides a finger-hold/access location for pulling/trying up the platform for cleaning of the reservoir.

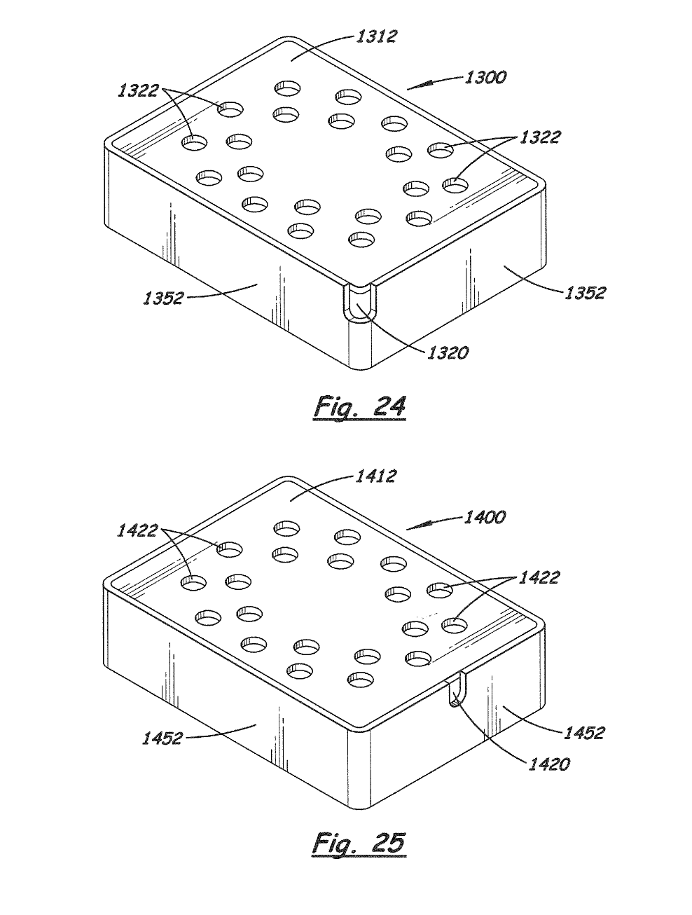

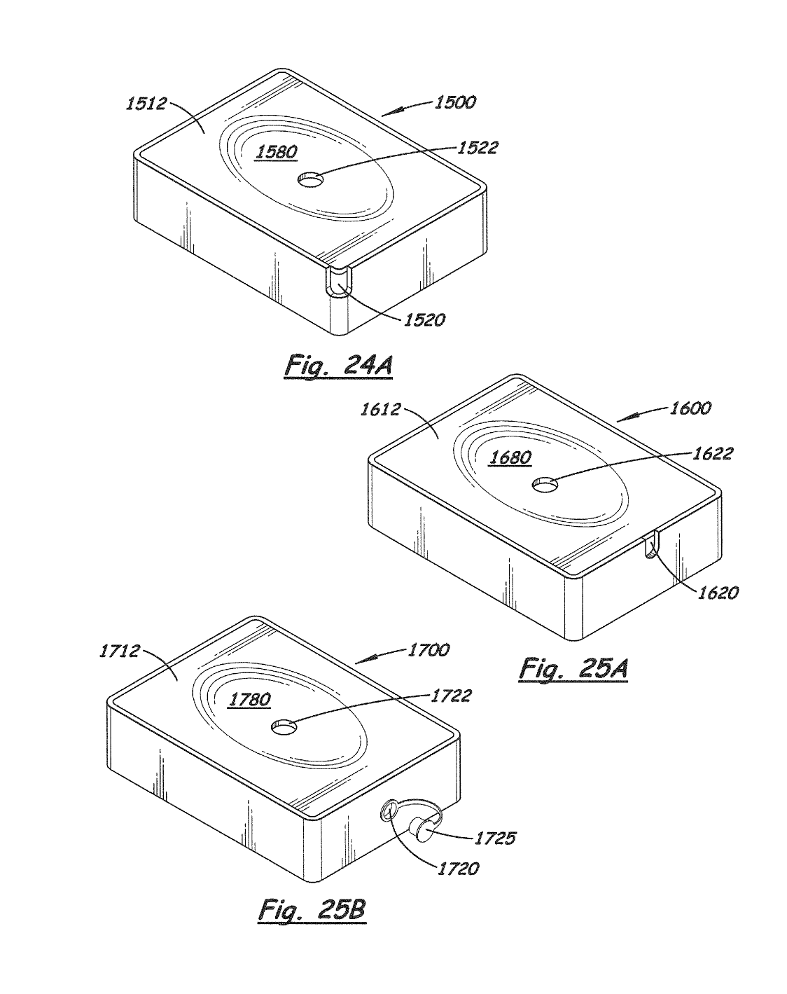

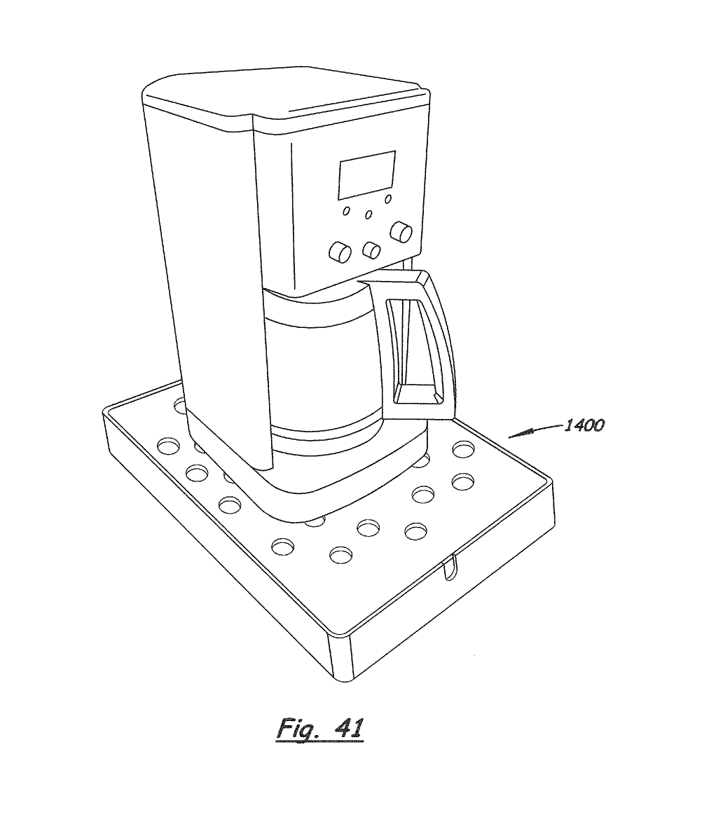

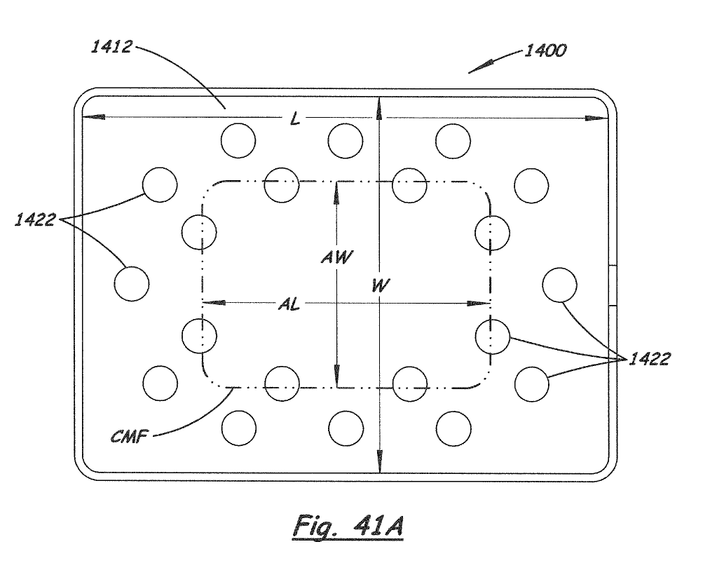

FIGS. 24 and 25 portray alternative embodiments, devices 1300 and 1400, each having a flat or substantially flat platform 1312, 1412 comprising multiple central apertures 1322, 1422. In addition, a spout aperture 1320, 1420 is provided in the sidewall 1352, 1452, formed, in effect, by lowering the sidewall at a corner and at an end, respectively, in device 1300 and 1400. Liquid overflowing, leaking or splashing from an appliance set on the device 1300 and 1400 will tend to flow into the apertures 1322, 1422, because of their location, number and arrangement, even though there is no upending liquid-dam rim. See FIG. 41, for example, wherein it is clear that the device 1400 is large compared to the footprint of the coffee maker and that liquid overflowing/leaking from the coffee maker will most likely encounter one or more apertures before reaching the sidewall of the device. After carrying the device 1300 and 1400 to a sink or other disposal area, the device may be tipped to position the spout aperture 1320, 1420 as the lowermost part of the device, for emptying the device through said spout aperture 1320, 1420.

FIGS. 24A and 25A illustrate devices 1500 and 1600, which comprise spout apertures 1520, 1620 similar to apertures 1320, 1420 that are provided in the sidewall of the device. The platforms 1512, 1612, however, of devices 1500, 1600, comprise a concave region 1580, 1680 onto which a small appliance is set, so that overflowing, leaking, or splashing liquid will tend to fall on the concave region 1580, 1680 and drain through the central apertures 1522, 1622 to the reservoir. A portion or the platform 1512, 1612 may be concave, or the entire platform may be concave. The size of the concave area may be designed based on the footprint of the appliance intended to be set on the device, with the goal being to capture all overflowing/leaking liquid without the need for any upending rim to dam the liquid.

FIG. 25B portrays an alternative device 1700, having one central aperture 1722 in the concave region 1780 and a drain hole 1720 in the end sidewall. Unlike aperture 1620, however, drain hole 1720 is lower on the sidewall and is not formed by lowering the sidewall. A removable plug 1725 is provided for sealing the hole 1720 during use with the appliance. Given a good seal between the plug 1725 and the hole 1720, the container of the device may be filled to a level above the hole 1720. In the case of non-plugged spout apertures in the sidewall, such as apertures 1320, 1420, 1522, 1622, it is important to size the reservoir and/or use the device so that the reservoir does not fill up so far as to reach the apertures, so that liquid (especially hot liquid) does not flow out or splash out of the apertures 1322, 1422, 1522, 1622. Alternatively, plugs or covers may be provided for any aperture if desired.

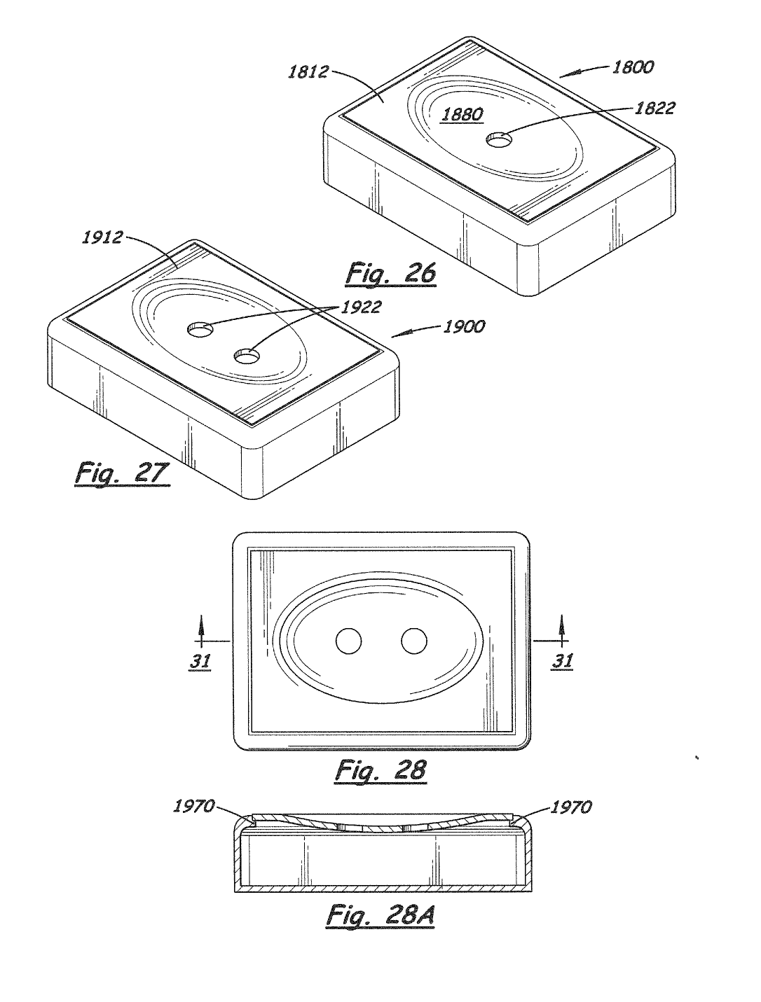

FIGS. 26 and 27 portray alternative embodiments, devices 1800 and 1900, that are similar to those in FIGS. 24A, 25A and B, except that there is no spout aperture or hole in the sidewall of the container. Device 1800 comprises one central aperture 1822 in the concave region 1880, and device 1900 comprises two central apertures 1922 in concave region 1990. The platforms 1812, 1912 of devices 1800 and 1900 may be removable, for example, by pulling up on the platform with one or more fingers placed in the apertures 1822, 1922. The platforms 1812, 1912 may rest on notches 1970 in the sidewall, wherein the platforms 1812, 1912 are removable from the sidewall/container by being liftable but are not liquid-sealed to the sidewall/container. FIGS. 28 and 28A show additional views of device 1900, helping the viewer see that a substantial portion, but not necessarily all, of the platform is concave. As understood from earlier discussion in this document, an appliance may be placed on the platform in various positions, but preferably so that the entire appliance footprint is within the concave portion so that overflowing/leaking liquid falls on the concave portion and into the central apertures 1922.

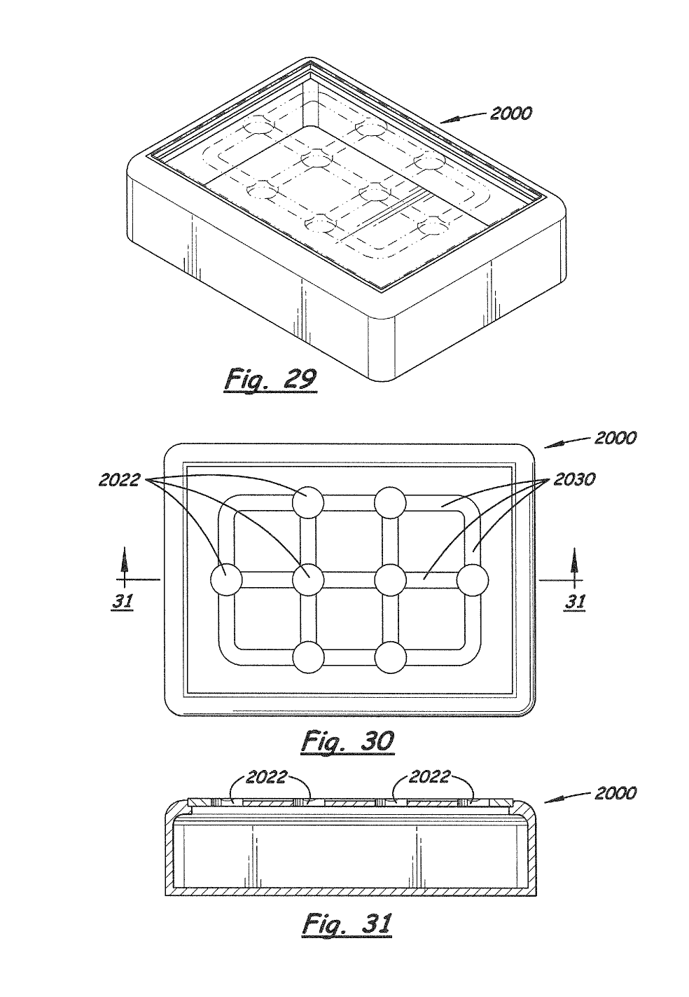

FIGS. 29-31 portray another embodiment, device 2000, which has no upending rim to dam liquid, but which relies on multiple central apertures 2022 and grooves/channels 2030 that direct liquid to the apertures 2022. Device 2000 does not comprise any corner/perimeter apertures, and no aperture surrounding the platform against the sidewall of the container. Because the combination of central apertures 2022 and grooves/channels 2030 extend all the way around the platform (both sides and both ends), and because the device is intended to be sized so that the appliance will rest entirely on the area inside the outermost “ring” of grooves/channels, the overflowing/leaking liquid will be captured in the grooves/channels and apertures before it reaches the sidewall of the container. In other words, the footprint of the appliance will be smaller and fully within the area defined by the outermost ring of grooves/channels. Hence, liquid will typically not overflow the device.

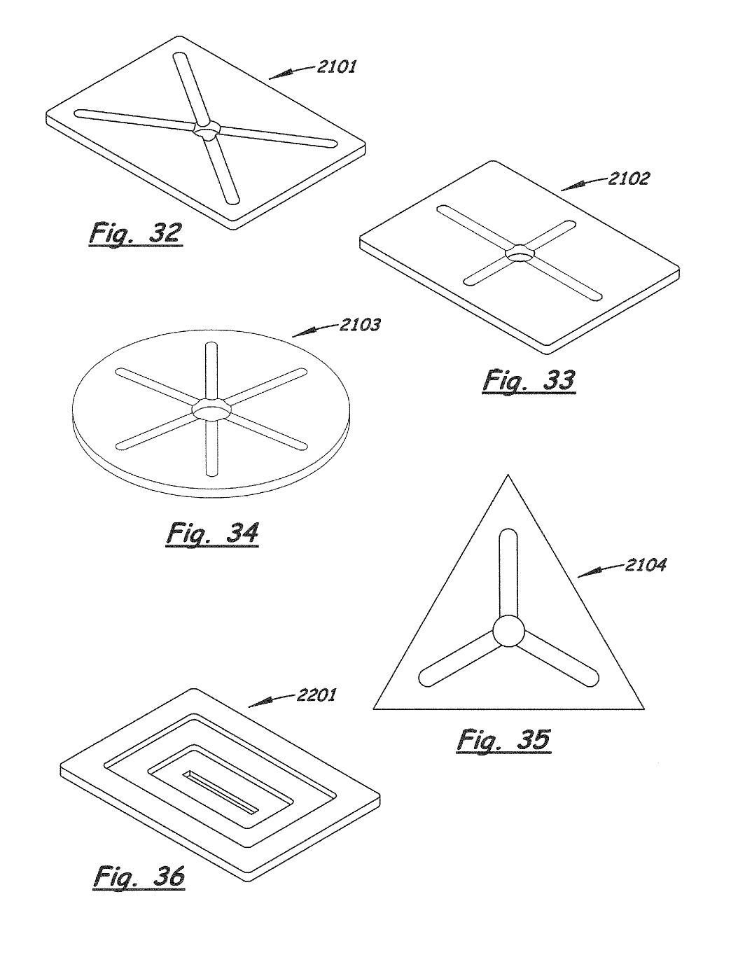

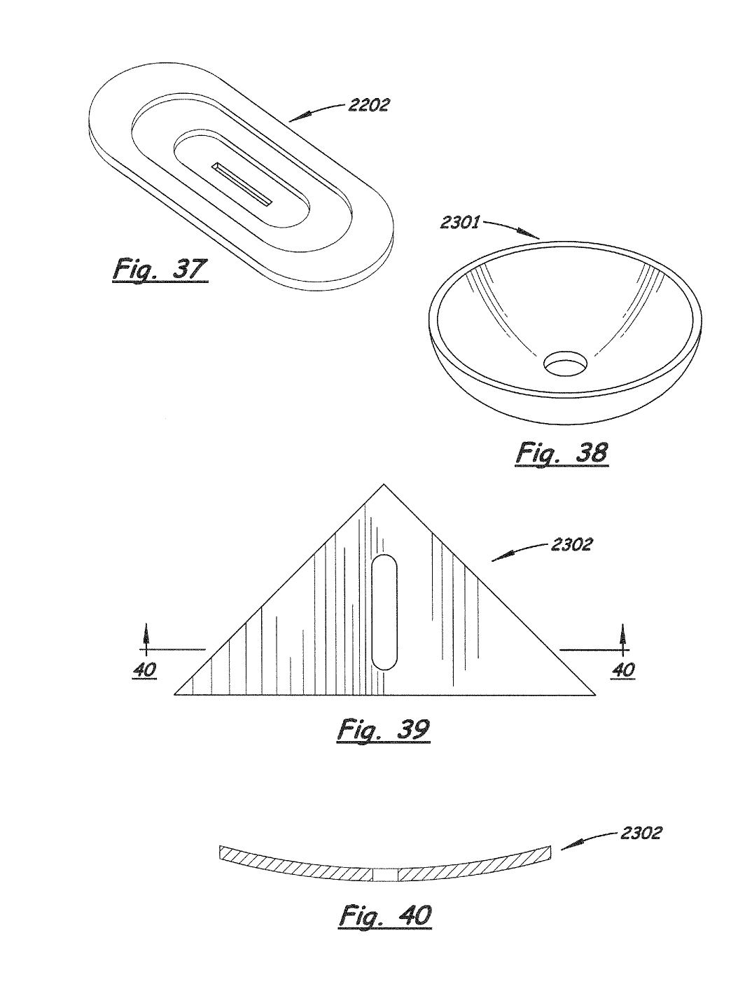

One may understand from this disclosure that many other variations of an upper platform may be effective. FIGS. 32-40 portray some of the many additional variations.

FIGS. 32-35 portray platform embodiments, platforms 2101, 2102, 2103, 2104, that comprise a single central aperture for receiving liquid and allowing it to flow into a container reservoir, wherein grooves/channels are also provided to direct liquid to the aperture. Various, but not all possible, platform shapes are shown and various, but not all possible, numbers and arrangements of grooves/channels are shown. For such platforms that rely on grooves/channels and one (or a few) central apertures, but not overall concavity of the platform, it is desirable to size the platform so that the appliance rests on an area of the platform near the center of the platform and well within (inward from) the outer extremity(ies) of the grooves/channels. In addition or alternatively, an upending rim may be provided on the sidewall of the container, or a perimeter aperture(s) may be provided between the sidewall and the platform, as discussed above, for prevent liquid from overflowing the device.

FIGS. 36 and 37 portray rectangular and oval platform embodiments, platforms 2201 and 2202, that comprise one or more central apertures, specifically in these embodiments, a single elongated slit. The platform surface around the central aperture is stepped, so that there are several levels of surface that are progressively lower toward the center.

FIGS. 38-40 portray circular and triangular platform embodiments, platforms 2301 and 2302, that comprises one or more central apertures (specially in these embodiments, a single central aperture that is a hole in platform 2301 and a slit in platform 2302) and concavity/slanting to direct liquid to the central aperture. As these platforms 2301, 2302 are shown to be entirely concave/slanted-toward-the-center, all liquid falling on the platform will normally flow to the central aperture. In addition or alternatively, an upending rim may be provided on the sidewall of the container, or a perimeter aperture(s) may be provided between the sidewall and the platform, as discussed above, for prevent liquid from overflowing the device.

FIG. 41 portrays an example coffee maker removably placed on an example embodiment of the device, specifically, device 1400 from FIG. 25. FIG. 41A is a top view of the embodiments of FIG. 41, wherein the coffee maker is not detailed but its footprint CMF is shown in dashed lines. Thus, it may be seen that certain embodiments of the device will accomplish liquid containment by virtue of the platform surface area being substantially larger than the footprint surface area of the appliance, so that the platform extends all around the appliance and extends substantially out from the horizontal extremity of the appliance on all sides of the appliance. For example, “substantially larger than the footprint surface area” may mean 50-300 percent larger, or more preferably 100-300 percent larger or at least 100 percent larger, than the footprint surface area. For example, “substantially out from the horizontal extremity of the appliance on all sides” may mean that the appliance may be generally centered on the device and the device having a minimum width W and a minimum length L that are each 50-300 percent larger or more preferably 100-300 percent larger or at least 100 percent larger, than the maximum width AW, and maximum length AL of the appliance footprint.

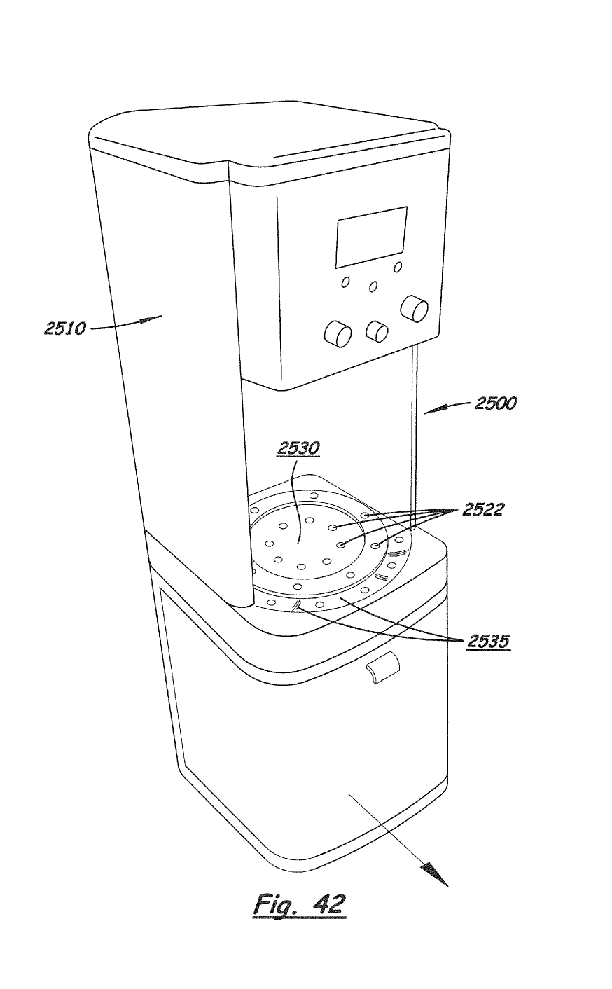

FIG. 42 portrays one, but not the only, embodiment of a beverage making system 2500, wherein the top end comprises a generally conventional coffee maker 2510 with modifications to include a container and adaptations so that the container receives liquid overflowing or leaking from the brewing basket and/or carafe. The coffee maker 2510 includes conventional cold water reservoir, pumping and heating systems to provide hot water to the brewing basket for flowing through coffee grounds in the basket, and support surfaces for supporting the carafe before, during, and after brewing. Adaptations beyond the scope of a conventional coffee maker may comprise draining apertures 2522 being provided in the surface(s) 2530, 2535 that support the carafe, and a removable container below said support surfaces. The draining apertures 2522 are in fluid communication with the space above the support surfaces, for they receive overflowing or leaking liquid, and with the container interior space.

Certain of the support surfaces adapted for liquid capture and conveyance to the container (for example, surface 2535) may be slanted inward to help contain/dam overflowing/leaking liquid from going outward beyond the outermost extremity of surface 2535, for example. The bottom end of the system 2500 comprises the drawer-style container that receives liquid draining through the apertures 2522 into its interior (reservoir) space. The drawer-style container may be open-topped or may comprise structure that mates with or otherwise cooperates with the apertures in the perforated surfaces, for example Preferably, the perforated surface(s) 2530, 2535 extend out horizontally farther than the footprint of the carafe, so that overflow liquid flowing down the outside of the carafe will fall to the perforated surface(s) 2530, 2535 and drain into the reservoir space of the drawer-style container rather than flowing down to the countertop, table, or floor underneath the system 2500. The volume of the drawer-style container is preferably greater than the volume the appliance can hold, or at least greater than the volume the carafe can hold.

In certain embodiments wherein the beverage maker includes adaptations for capture of overflowing/leaking liquid and conveyance of the liquid to a removable container, the perforated surface(s) are, or are portions of, the support and heating plate for the carafe. In other embodiments the perforated surface(s) 2530, 2535 are, or are portions of, a support plate for the carafe that is not heated. Whether the perforated surfaces are heated and/or near heating surfaces, or not heated or near heated surfaces, the various heating elements and other electrical portions of the beverage maker will be safely isolated, separated, or otherwise protected from the overflowing liquid that flows through the apertures and into the drawer-style container.

Certain embodiments may be described as an overflow protection device for supporting a small appliance having a foot print and using liquid, the device being adapted to capture overflowing or leaking liquid from the appliance, wherein the device comprises: a lower container portion comprising a bottom wall and a sidewall defining an interior reservoir space; an upper platform above the lower container portion, the upper platform having an upper surface area comprising a portion for removably receiving the appliance; and one or more apertures from the upper platform to the interior reservoir space; wherein said sidewall is an outermost extremity of the device, and wherein at least one of said one or more apertures is an outer perimeter aperture located at the outer perimeter of the upper platform so that overflowing or leaking liquid flowing outward on the platform falls into said outer perimeter aperture before reaching the sidewall. The device may be empty-able by tipping the device so that liquid flows out of said outer perimeter aperture. The outer perimeter aperture may extend all around the platform or substantially all around the platform, for example. The platform may be supported by ledges extending from the sidewall inward to be underneath the platform and/or by supported by pillars inside the interior reservoir space, for example. One may regard the outer perimeter aperture as a gap between the sidewall and an edge of the platform. From viewing the drawings, one may understand that the device may comprise at least one additional aperture that is an aperture in the sidewall for pouring liquid contained inside the interior reservoir out to a disposal site. For example, the aperture in the sidewall may be at a top edge of the sidewall or below a top edge of the sidewall in which case a plug or cover for the aperture in the sidewall would preferably be provided. While the liquid preferably flows easily and reliably into the lower container through the outer perimeter aperture, additional structure may be provided, for example, means for directing liquid selected from the group consisting of: an upending rim extending entire or substantially entirely around an outer region of the device, a concave region of the platform, one or more channels in the platform, one or more recesses in the platform, one or more stepped surfaces in the platform, and rims or ridges that direct liquid flow to said one or more apertures and/or particularly to the outer perimeter aperture. In certain embodiments, the upper extremity of the sidewall is at or below the level of the platform. The device and the platform may be formed in various shapes, for example, rectangular device/shape, a square device/shape, a circular device/shape, an oval de vice/shape, and a triangular device/shape. The platform may be latched to the sidewall and/or may be connected to one or more pillars in the interior reservoir, for example.

Certain embodiments may be described as an overflow protection device for supporting a small appliance having a foot print and using liquid, the device being adapted to capture overflowing or leaking liquid from the appliance, wherein the device comprises: an upper platform having an upper surface area comprising a portion for removably receiving the small appliance; one or more apertures from the upper platform to an interior reservoir space of the device; and means for directing overflowing or leaking liquid that falls on the upper platform to said one or more apertures. The means for directing may be selected from the group consisting of, for example: an upending rim extending entire or substantially entirely around an outer region of the device, a concave region of the platform, one or more channels in the platform, one or more recesses in the platform, one or more stepped surfaces in the platform, and rims or ridges that direct liquid flow to said one or more apertures. The device may comprise a sidewall that is an outermost extremity of the device, and wherein the device comprises at least one additional aperture that is an aperture in the sidewall for pouring liquid contained inside the interior reservoir out to a disposal site. Such an aperture in the sidewall may be at a top edge of the sidewall or may be below a top edge of the sidewall (wherein the device preferably comprises a plug or cover for the aperture in the sidewall). Relying on directing means that are selected from a concave region of the platform, one or more channels in the platform, one or more recesses in the platform, one or more stepped surfaces in the platform, and rims or ridges that direct liquid flow to said one or more apertures, the sidewall that is the outermost extremity of the device may rise in certain embodiments to at or below the level of the uppermost surface of the platform, in effect therefore, the device not having said upending rim extending entire or substantially entirely around an outer region of the device. Or, in certain embodiments, the only directing means is said upending rim extending entire or substantially entirely around an outer region of the device, for example, wherein the upper extremity of the sidewall is above the level of the uppermost surface of the platform. Or, in certain embodiments, one or more additional directing means may be included in addition to an upending rim extending entire or substantially entirely around an outer region of the device (again, the upper extremity of the sidewall would be above the level of the uppermost surface of the platform).

Certain embodiments may be described as an overflow protection system comprising a small electrical appliance having a foot print and using liquid; and a device adapted to capture overflowing or leaking liquid from the electrical appliance, wherein the device comprises an upper platform having an upper surface area comprising a portion removably receiving the electrical appliance, the platform upper surface area being substantially larger than the footprint of the electrical appliance and the upper surface area extending underneath and all around the appliance and extending horizontally out beyond the appliance footprint all around the appliance, so that the overflowing or leaking liquid will fall on the platform; wherein the device comprises one or more apertures from the upper platform to an interior reservoir space of the device so that said overflowing or leaking liquid flows through the one or more apertures into the reservoir space. The device may be removable from the appliance and empty-able by tipping the device so that the liquid flows out of the one or more apertures. The device may comprise a sidewall that is an outermost extremity of the device, and wherein the device comprises at least one additional aperture that is an aperture in the sidewall for pouring liquid contained inside the interior reservoir out to a disposal site. The aperture in the sidewall may be at a top edge of the sidewall and/or below a top edge of the sidewall and wherein the device comprises a plug or cover for the aperture in the sidewall. The device may further comprise means for directing overflowing or leaking liquid from the electrical appliance, that falls on the upper platform to said one or more apertures, the means for directing being selected from the group consisting of: an upending rim extending entire or substantially entirely around an outer region of the device, a concave region of the platform, one or more channels in the platform, one or more recesses in the platform, one or more stepped surfaces in the platform, and rims or ridges that direct liquid flow to said one or more apertures.

Certain embodiments may be described as an overflow container built-in to a beverage maker, for example: a combination of a coffee maker and a liquid overflow container adapted for capturing liquid overflowing or leaking from the coffee maker, the combination comprising a brewing basket for containing coffee grounds and adapted to receive hot liquid for brewing of coffee, a carafe, and a support surface for supporting the carafe in a space above the support surface and below the brewing basket for receiving the brewed coffee; and a container provided below the support surface and having an interior space; wherein the support surface comprises apertures that are in fluid communication with said space above the support surface and with said interior space of the container, the apertures adapted to receive liquid overflowing or leaking from the brew basket or the carafe and conveying the liquid to the interior space; and wherein the container is removable from below the support surface for being carried away to dispose of the liquid, for example, by tilting the container to pour the liquid out of the container.

In certain embodiments, the platform is a single piece resting on, latched to, sealed to or otherwise connected to the container. In certain embodiments, the platform is not hinged to the container or otherwise pivotally connected.

Although this invention has been described above with reference to particular means, materials and embodiments, it is to be understood that the invention is not limited to these disclosed particulars, but extends instead to all equivalents within the scope of the following claims.

We claim:

1. An overflow protection device for supporting a small appliance having a foot print and using liquid, the device being adapted to capture overflowing or leaking liquid from the appliance, wherein the device comprises:
a lower container portion comprising a bottom wall and a sidewall defining an interior reservoir space;
an upper platform above the lower container portion, the upper platform having an upper surface area comprising a portion for removably receiving the appliance; and
one or more apertures from the upper platform to the interior reservoir space;
wherein said sidewall is an outermost extremity of the device, and wherein at least one of said one or more apertures is an outer perimeter aperture located at the outer perimeter of the upper platform so that overflowing or leaking liquid flowing outward on the platform falls into said outer perimeter aperture before reaching the sidewall.

2. The device of claim 1, wherein the device is empty-able by tipping the device so that liquid flows out of said outer perimeter aperture.

3. The device of claim 1, wherein the outer perimeter aperture extends all around the platform.

4. The device of claim 1, wherein the outer perimeter aperture extends substantially all around the platform.

5. The device of claim 1, wherein the platform is supported by ledges extending from the sidewall inward to be underneath the platform.

6. The device of claim 1, wherein the platform is supported by pillars inside the interior reservoir space.

7. The device of claim 1 wherein the outer perimeter aperture is a gap between the sidewall and an edge of the platform.

8. The device of claim 1, wherein said device comprises at least one additional aperture that is an aperture in the sidewall for pouring liquid contained inside the interior reservoir out to a disposal site.

9. The device of claim 8, wherein the aperture in the sidewall is at a top edge of the sidewall.

10. The device of claim 8, wherein the aperture in the sidewall is below a top edge of the sidewall and wherein the device comprises a plug or cover for the aperture in the sidewall.

11. The device of claim 1, wherein the sidewall comprises an upending rim rising above the platform.

12. The device of claim 1, wherein the upper extremity of the sidewall is at or below the level of the platform.

13. The device of claim 1, wherein the device comprises means for directing said overflowing or leaking liquid that falls on the upper platform to said outer perimeter aperture, the means for directing being selected from the group consisting of: an upending rim extending entire or substantially entirely around an outer region of the device, a concave region of the platform, one or more channels in the platform, one or more recesses in the platform, one or more stepped surfaces in the platform, and rims or ridges that direct liquid flow to said one or more apertures.

14. The device of claim 1, wherein the device is selected from a group consisting of: a rectangular device, a square device, a circular device, an oval de vice, and a triangular device.

15. The device of claim 1, wherein the platform is latched to the sidewall.

16. The device of claim 1, further comprising one or more pillars in the interior reservoir, and the platform is connected to at least one of the one or more pillars.

17. An overflow protection device for supporting a small appliance having a foot print and using liquid, the device being adapted to capture overflowing or leaking liquid from the appliance, wherein the device comprises:
an upper platform having an upper surface area comprising a portion for removably receiving the small appliance;
one or more apertures from the upper platform to an interior reservoir space of the device; and
means for directing overflowing or leaking liquid that falls on the upper platform to said one or more apertures.

18. The device of claim 17, wherein the means for directing is selected from the group consisting of: an upending rim extending entire or substantially entirely around an outer region of the device, a concave region of the platform, one or more channels in the platform, one or more recesses in the platform, one or more stepped surfaces in the platform, and rims or ridges that direct liquid flow to said one or more apertures.

19. The device of claim 17, wherein said device comprises a sidewall that is an outermost extremity of the device, and wherein the device comprises at least one additional aperture that is an aperture in the sidewall for pouring liquid contained inside the interior reservoir out to a disposal site.

20. The device of claim 19, wherein the aperture in the sidewall is at a top edge of the sidewall.

21. The device of claim 19, wherein the aperture in the sidewall is below a top edge of the sidewall and wherein the device comprises a plug or cover for the aperture in the sidewall.

22. The device of claim 17, wherein the device comprises a sidewall that is the outermost extremity of the device, wherein the upper extremity of the sidewall is at or below the level of the uppermost surface of the platform.

23. The device of claim 17, wherein the device comprises a sidewall that is the outermost extremity of the device, wherein the upper extremity of the sidewall is above the level of the uppermost surface of the platform.

24. An overflow protection system comprising:
a small electrical appliance having a foot print and using liquid; and
a device adapted to capture overflowing or leaking liquid from the electrical appliance, wherein the device comprises an upper platform having an upper surface area comprising a portion removably receiving the electrical appliance, the platform upper surface area being substantially larger than the footprint of the electrical appliance and the upper surface area extending underneath and all around the appliance and extending horizontally out beyond the appliance footprint all around the appliance, so that the overflowing or leaking liquid will fall on the platform;
wherein the device comprises one or more apertures from the upper platform to an interior reservoir space of the device so that said overflowing or leaking liquid flows through the one or more apertures into the reservoir space.

25. The system of claim 24, wherein the device is removable from the appliance and empty-able by tipping the device so that the liquid flows out of the one or more apertures.

26. The system of claim 24, wherein said device comprises a sidewall that is an outermost extremity of the device, and wherein the device comprises at least one additional aperture that is an aperture in the sidewall for pouring liquid contained inside the interior reservoir out to a disposal site.

27. The system of claim 26, wherein the aperture in the sidewall is at a top edge of the sidewall.

28. The system of claim 26, wherein the aperture in the sidewall is below a top edge of the sidewall and wherein the device comprises a plug or cover for the aperture in the sidewall.

29. The system of claim 24, wherein the device further comprises means for directing overflowing or leaking liquid from the electrical appliance, that falls on the upper platform to said one or more apertures, the means for directing being selected from the group consisting of: an upending rim extending entire or substantially entirely around an outer region of the device, a concave region of the platform, one or more channels in the platform, one or more recesses in the platform, one or more stepped surfaces in the platform, and rims or ridges that direct liquid flow to said one or more apertures.

30. A combination of a coffee maker and a liquid overflow container adapted for capturing liquid overflowing or leaking from the coffee maker, the combination comprising:
a brewing basket for containing coffee grounds and adapted to receive hot liquid for brewing of coffee, a carafe, and a support surface for supporting the carafe in a space above the support surface and below the brewing basket for receiving the brewed coffee; and
a container provided below the support surface and having an interior space;
wherein the support surface comprises apertures that are in fluid communication with said space above the support surface and with said interior space of the container, the apertures adapted to receive liquid overflowing or leaking from the brew basket or the carafe and conveying the liquid to the interior space; and
wherein the container is removable from below the support surface for being carried away to dispose of the liquid, by tilting the container to pour the liquid out of the container.
